(19) United States
(12) Patent Application Publication
(10) Pub. No.: US 2026/0238956 A1
(43) Pub. Date: Aug. 13, 2026

(54) METHOD FOR CREATION OF LINEARLY INTERPOLATED HEAD RELATED TRANSFER FUNCTIONS

(71) Applicant: DOLBY LABORATORIES LICENSING CORPORATION

(72) Inventor: David S. MCGRATH, Rose Bay (AU)

(73) Assignee: DOLBY LABORATORIES LICENSING CORPORATION, (US)

(21) Appl. No.: 19/469,293

(22) PCT Filed: Mar. 20, 2024
(86) PCT No.: PCT/US24/20786

§ 371 Date: Sep. 25, 2025

Related U.S. Application Data
(60) Provisional application No. 63/455,539, filed on Mar. 29, 2023.
(60) Provisional application No. 63/595,752, filed on Nov. 2, 2023.
(60) Provisional application No. 63/567,376, filed on Mar. 19, 2024.

(51) Int. Cl. H04S 7/00; H04R 3/12

(52) U.S. Cl. CPC H04S 7/307; H04R 3/12; H04S 2420/01

(57) ABSTRACT

Systems, devices, and methods are described for determining a “coupled” pair of Left/Right ear Head Related Transfer Functions (HRTFs) that are adapted from an original pair of Left/Right ear HRTFs, wherein the inter-aural delay of the coupled HRTFs is formed using all-pass filters that provide the correct inter-aural delay at low frequencies. The all-pass filters are adapted to limit the inter-aural phase difference at high frequencies. Furthermore, a low-complexity process is described for rapid generation of suitable all-pass filters.

### CROSS-REFERENCE TO RELATED APPLICATIONS

This application claims priority to U.S. Provisional Application No. 63/455,539, filed Mar. 29, 2023, U.S. Provisional Application No. 63/595,752, filed Nov. 2, 2023, and U.S. Provisional Application No. 63/567,376, filed Mar. 19, 2024, the entire contents of which are hereby incorporated by reference.

### TECHNICAL FIELD

The present disclosure relates to the creation of modified head related transfer functions (HRTFs) from original HRTFs.

### BACKGROUND

Unless otherwise indicated herein, the approaches described in this section are not prior art to the claims in this application and are not admitted to be prior art by inclusion in this section.

Binaural audio signals comprise two audio channels intended for playback to a listener through two (left and right) respective ears. Binaural playback may be achieved via loudspeakers placed close to each ear, or through headphones (including over-ear and in-ear headphones).

Binaural signals may be generated by processing a source audio signal with a pair of head-related transfer function (HRTF) filter responses. HRTF responses may be defined in many ways, including as time-domain impulse responses or as frequency-domain responses. HRTF responses are typically grouped in pairs, to provide a response for each ear transducer.

When used to process an audio signal, an HRTF filter pair may be used to provide a listener with an experience that mimics the sound (at each ear) that would occur when the audio signal was presented from a particular direction of arrival. Different HRTF filter pairs will produce the illusion of differing sound-source directions.

A pair of reference HRTF filters, associated with a particular direction of arrival, may be determined by measuring the acoustic transfer function from a sound source, located at some distance in the same direction, to each of a listener's ears. Alternatively, reference HRTF filters may be determined by other means, including numerical simulation, or acoustic measurement of a mannequin.

A pair of modified HRTF filters may differ from a pair of acoustically measured HRTF filters, while still providing a listener with the desired impression of a sound from the same direction. In particular, the phase-difference between the high-frequency portion of the left and right modified HRTF filters may differ substantially from the phase-difference between the high-frequency portion of the left and right reference HRTF filters, without significant loss of the perceived listener experience. This is possible because the inter-aural phase difference, in a high frequency range, is largely unimportant with respect to a listener's perception.

An HRTF set function is a function that, given a direction-of-arrival, determines the left and right ear HRTF filters:

$$( {h}_{l} ( t ) , {h}_{r} ( t ) ) ← \text{?} ( x , y , z ) \qquad ( 1 )$$

In Equation 1, the HRTF set function, [symbol] (x, y, z) is provided with a direction of arrival in the form of a 3D unit-vector (x, y, z), and the function returns a pair of left/right ear HRTF filters.

It is with respect to these and other considerations that the disclosure made herein is presented.

### SUMMARY

Techniques are described for processing audio signals. Various examples described herein provide for systems, methods, and/or devices for the creation and use of modified HRTF filters with alternative high-frequency phase response.

According to some example embodiments, an audio processing method for a control system including one or more processors may involve obtaining, by the control system, a first set of head-related transfer functions (HRTFs) and transforming, by the control system, the first set of HRTFs to a second set of HRTFs. In some example embodiments, the transforming may involve replacing delay components of the first set of HRTFs with all-pass filters in the second set of HRTFs. In some example embodiments, the transforming may involve adjusting a phase response of each of the all-pass filters in the second set of HRTFs such that each inter-aural phase response is substantially linear for frequencies below an associated threshold frequency of the corresponding all-pass filter, and each phase response has reduced inter-aural phase difference for frequencies above the associated threshold frequency of the corresponding all-pass filter.

In some example embodiments, the method may involve outputting the second set of HRTFs. According to some example embodiments, outputting the second set of HRTFs may involve storing the second set of HRTFs, transmitting the second set of HRTFs to a device that is configured to process audio data, providing the second set of HRTFs for further processing, or combinations thereof.

According to some example embodiments, the method may involve defining, by the control system, a set of basis filters based on the second set of HRTFs. The set of basis filters may have fewer members than the second set of HRTFs. In some example embodiments, the method may involve obtaining, by the control system, a bitstream of input audio data in an input audio format and combining, by the control system, the input audio data with one or more basis filters of the set of basis filters to produce left audio data and right audio data.

In some example embodiments, the method may involve outputting, by the control system, the left audio data and the right audio data. According to some example embodiments, outputting the left audio data and the right audio data may involve storing the left audio data and the right audio data, transmitting the left audio data and the right audio data, providing, by the control system, the left audio data and the right audio data to a set of loudspeakers for playback, providing the left audio data and the right audio data for further processing, or combinations thereof.

According to some example embodiments, the transforming also may involve obtaining left ear HRTFs and right ear HRTFs from the first set of HRTFs, identifying a left ear non-delayed impulse response and a left ear delay from each of the left ear HRTFs and identifying a right ear non-delayed impulse response and a right ear delay from each of the right ear HRTFs. In some example embodiments, the transforming also may involve producing left ear all-pass filters, each of the left ear all-pass filters being based, at least in part, on an instance of the left ear delays. According to some example embodiments, the transforming also may involve producing right ear all-pass filters, each of the right ear all-pass filters being based, at least in part, on an instance of the right ear delays. In some example embodiments, the transforming also may involve combining instances of the left ear and a right ear non-delayed impulse responses with corresponding instances of the left ear and right ear all-pass filters to produce HRTF pairs of the second set of HRTFs.

In some example embodiments, the method also may involve producing modified left ear delay values and modified right ear delay values based on one or more of the extracted left ear delays and right ear delays. The left ear all-pass filters and right ear all-pass filters may be based upon the modified left ear delay values and modified right ear delay values.

According to some example embodiments, producing instances of the modified left ear delay values and right ear delay values may involve determining a difference between an extracted left ear delay and an extracted right ear delay. In some such example embodiments, producing instances of the modified left ear delay values and right ear delay values may involve determining a largest expected difference between an extracted left ear delay and an extracted right ear delay. According to some example embodiments, a difference between an extracted left ear delay and an extracted right ear delay may equal a difference between a corresponding modified left ear delay value and a modified right ear delay value.

In some example embodiments, the modified left ear delay values and the modified right ear delay values may correspond to smooth functions. According to some example embodiments, each pair of the modified left ear delay values and modified right ear delay values may include a lower delay value and a higher delay value. In some examples, the lower delay value may have less delay variation than the higher delay value. In some example embodiments, the non-delayed impulse responses may be minimum-phase filter responses.

According to some example embodiments, extracting each left ear non-delayed impulse response, each right ear non-delayed impulse response, each left ear delay and each right ear delay from each of the left ear and right ear HRTFs may involve determining a frequency response of an original HRTF filter of the first set of HRTFs, determining a magnitude response of the original HRTF filter and determining a minimum-phase frequency response of a new non-delayed minimum-phase filter. In some such example embodiments, extracting each left ear non-delayed impulse response, each right ear non-delayed impulse response, each left ear delay and each right ear delay from each of the left ear and right ear HRTFs may involve determining a phase response of the original HRTF filter and a phase response of the new non-delayed minimum-phase filter and determining a delay associated with the original HRTF filter based, at least in part, on the phase response of the original HRTF filter and the phase response of the new non-delayed minimum-phase filter. In some such example embodiments, determining the minimum-phase frequency response may involve implementing a Hilbert transform involving the magnitude response of the original HRTF filter. According to some example embodiments, determining the delay associated with the original HRTF filter may also be based, at least in part, on a delay measurement frequency in a range of 300 Hz to 1600 Hz.

In some example embodiments, the set of basis filters may have at least an order of magnitude fewer members than the second set of HRTFs. According to some example embodiments, an all-pass phase response may deviate from a linear-ramp phase response and may smoothly approach zero phase for frequencies above the threshold frequency.

According to some example embodiments, the control system may correspond to at least part of a codec for Immersive Voice and Audio Services (IVAS).

According to some further embodiments, one or more non-transitory computer-readable media may store instructions that, when executed by one or more processors, cause the one or more processors to perform operations of any one of the methods disclosed herein.

According to some additional example embodiments, an audio processor device may be configured to process input audio data. In some example embodiments, the audio processor device may include a receiver unit configured to receive the input audio data and a computer unit. According to some example embodiments, the computer unit may be configured to retrieve a first set of head-related transfer functions (HRTFs) and to transform the first set of HRTFs to a second set of HRTFs. In some example embodiments, the transforming may involve replacing delay components of the first set of HRTFs with all-pass filters in the second set of HRTFs. In some example embodiments, the transforming may involve adjusting a phase response of each of the all-pass filters in the second set of HRTFs such that each inter-aural phase response is substantially linear for frequencies below an associated threshold frequency of the corresponding all-pass filter, and each phase response has reduced inter-aural phase difference for frequencies above the associated threshold frequency of the corresponding all-pass filter.

In some example embodiments, the computer unit may be configured to output the second set of HRTFs. According to some example embodiments, outputting the second set of HRTFs may involve storing the second set of HRTFs, transmitting the second set of HRTFs to a device that is configured to process audio data, providing the second set of HRTFs for further processing, or combinations thereof.

According to some example embodiments, the computer unit may be further configured to define a set of basis filters based on the second set of HRTFs. The set of basis filters may have fewer members than the second set of HRTFs. In some example embodiments, the computer unit may be further configured to obtain a bitstream of input audio data in an input audio format and to combine the input audio data with one or more basis filters of the set of basis filters to produce left audio data and right audio data.

In some example embodiments, the computer unit may be further configured to output the left audio data and the right audio data. According to some example embodiments, outputting the left audio data and the right audio data may involve storing the left audio data and the right audio data, transmitting the left audio data and the right audio data, providing, by the control system, the left audio data and the right audio data to a set of loudspeakers for playback, providing the left audio data and the right audio data for further processing, or combinations thereof.

According to some example embodiments, the audio processor device may include a storage device that is configured to store the first HRTFs, the second HRTFs, the left audio data, the right audio data, the input audio data, or combinations thereof. In some such example embodiments, the storage device may include a random-access memory, a read-only memory, a non-transitory computer readable medium, or combinations thereof.

In some example embodiments, the audio processor device may correspond to at least part of a codec for Immersive Voice and Audio Services (IVAS).

The embodiments described herein may be generally described as techniques, where the term “technique” may refer to system(s), device(s), method(s), computer-readable instruction(s), module(s), component(s), hardware logic, and/or operation(s) as suggested by the context as applied herein.

Features and technical benefits other than those explicitly described above will be apparent from a reading of the following Detailed Description and a review of the associate drawings. This Summary is provided to introduce a selection of techniques in a simplified form, and not intended to identify key or essential features of the claimed subject matter, which are defined by the appended claims.

### BRIEF DESCRIPTION OF THE DRAWINGS

Embodiments of the invention will now be described, by way of example only, with reference to the accompanying drawings in which:

FIG. 1A is a block diagram that shows examples of components of an apparatus capable of implementing various aspects of this disclosure;

FIG. 1B illustrates a schematic block diagram of an example device architecture that may be used to implement various aspects of the present disclosure;

FIG. 1C illustrates a schematic block diagram of an example CPU implemented in the device architecture of FIG. 1B that may be used to implement various aspects of the present disclosure;

FIG. 1D is a block diagram of an immersive voice and audio services (IVAS) coder/decoder (“codec”) framework for encoding and decoding IVAS bitstreams, according to one or more embodiments;

FIG. 1E is a diagram showing a Cartesian coordinate system centered on a listener's head;

FIG. 2 is a plot showing a left ear reference HRTF;

FIG. 3 is a plot showing a right ear reference HRTF;

FIG. 4 is a plot showing a right ear HRTF filter with delay removed;

FIG. 5 is a plot showing the phase responses of two alternative filters;

FIG. 6 is a plot showing the phase responses of two alternative filters;

FIG. 7 is a plot showing a left ear modified HRTF;

FIG. 8 is a plot showing a right ear modified HRTF;

FIG. 9 is a plot showing a left ear HRTF with added delay;

FIG. 10 is a plot showing a right ear modified HRTF;

FIG. 11 is a diagram showing the modification of an HRTF filter;

FIG. 12 is a diagram showing the formation of an all-pass impulse response with an associated delay;

FIG. 13 is a diagram showing the conversion of an original HRTF library to a more compact HRTF basis-set;

FIG. 14 is a diagram showing a compact HRTF basis-set utilized to compute HRTFs efficiently;

FIG. 15 is a diagram showing a compact HRTF basis-set utilized to process a scene-based audio signal;

FIG. 16 shows additional details of the HRTF transformation block of FIGS. 13-15 according to some implementations;

FIG. 17 shows additional details of the HRTF transformation sub-blocks of FIG. 16 according to some implementations;

FIGS. 18, 19, and 20 show examples of functions that may be implemented by the delay processing block of FIG. 17; and

FIG. 21 is a flow diagram that outlines one example of a method that may be performed by an apparatus or system such as those disclosed herein.

### DETAILED DESCRIPTION

The present disclosure relates to the creation of modified HRTFs from original HRTFs, such that the modified HRTFs may be more efficiently approximated by a linear mixture while preserving the psychoacoustic properties of the original HRTFs. Described herein are techniques related to processing of HRTF filters to produce modified HRTF filters that are suitable for being used in a set of filters based on linear interpolation. In the following description, for purposes of explanation, numerous examples and specific details are set forth in order to provide a thorough understanding of the present disclosure. It will be evident, however, to one skilled in the art that the present disclosure as defined by the claims may include some or all of the features in these examples alone or in combination with other features described below, and may further include modifications and equivalents of the features and concepts described herein.

In the following description, various systems, devices, methods, processes and procedures are detailed. Although particular steps may be described in a certain order, such order is mainly for convenience and clarity. A particular step may be repeated more than once, may occur before or after other steps (even if those steps are otherwise described in another order), and may occur in parallel with other steps. A second step is required to follow a first step only when the first step must be completed before the second step is begun. Such a situation will be specifically pointed out when not clear from the context.

In this document, the terms “and”, “or” and “and/or” are used. Such terms are to be read as having an inclusive meaning. For example, “A and B” may mean at least the following: “both A and B”, “at least both A and B”. As another example, “A or B” may mean at least the following: “at least A”, “at least B”, “both A and B”, “at least both A and B”. As another example, “A and/or B” may mean at least the following: “A and B”, “A or B”. When an exclusive- or is intended, such will be specifically noted (e.g., “either A or B”, “at most one of A and B”).

The term “includes” and its variants are to be read as open-ended terms that mean “includes, but is not limited to.” The term “one example implementation” and “an example implementation” are to be read as “at least one example implementation.” The term “another implementation” is to be read as “at least one other implementation.” The terms “determined,” “determines,” or “determining” are to be read as obtaining, receiving, computing, calculating, estimating, predicting, or deriving. In addition, in the following description and claims, unless defined otherwise, all technical and scientific terms used herein have the same meaning as commonly understood by one of ordinary skills in the art to which this disclosure belongs.

This document describes various processing functions that are associated with structures such as blocks, elements, components, circuits, etc. In general, these structures may be implemented by a processor that is controlled by one or more computer programs.

Various Acronyms may appear throughout this disclosure and in the associated claims and/or drawings are listed below. Other commonly used acronyms and terms of art may be excluded from this list in the interest of brevity. Thus, a short list of acronyms is provided below as an easy reference for the reader.
IVAS—Immersive Voice and Audio Services
HRTF—Head Related Transfer Function
LPC—Linear Predictive Coding
CLDFB—Complex Low Delay Filter Bank
SBA—Scene Based Audio
SPAR—Spatial Reconstruction, a spatial audio coding technology
DirAC—Directional Audio Coding, another spatial audio coding technology
MD—Metadata
BS—Bitstream
HOA—Higher Order Ambisonics
FOA—First Order Ambisonics
MDFT—Modified Discrete Fourier Transform
MDCT—Modified Discrete Cosine Transform

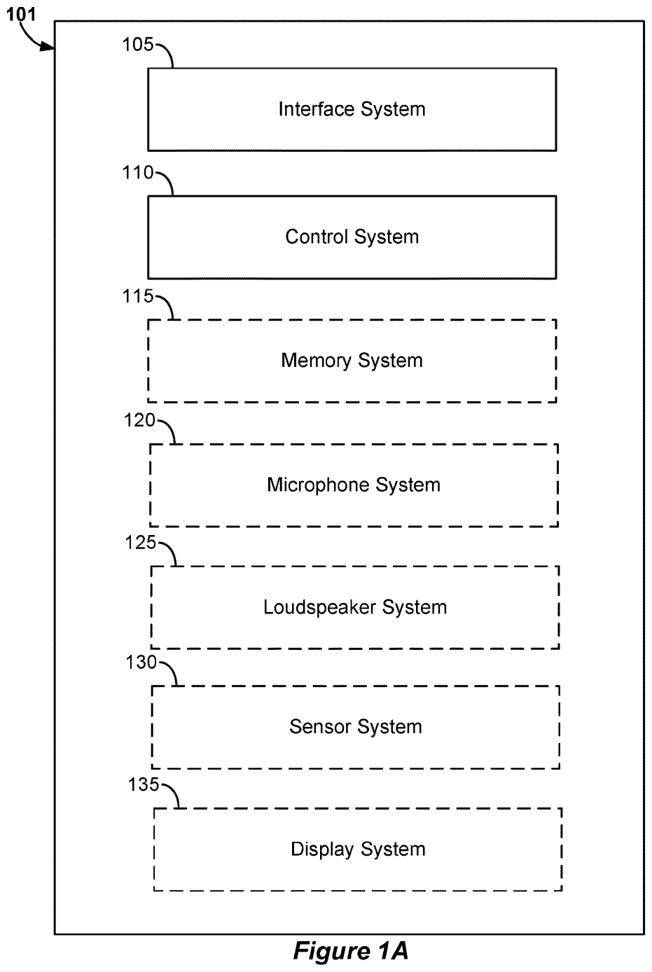

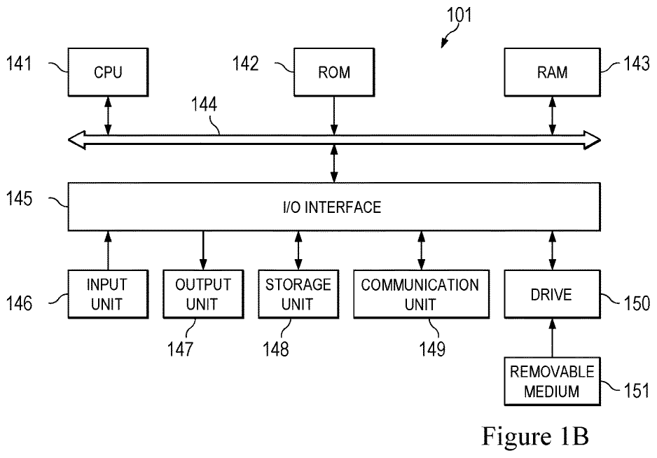

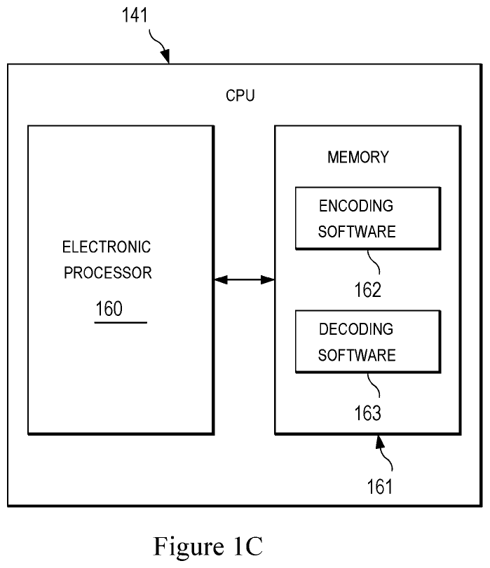

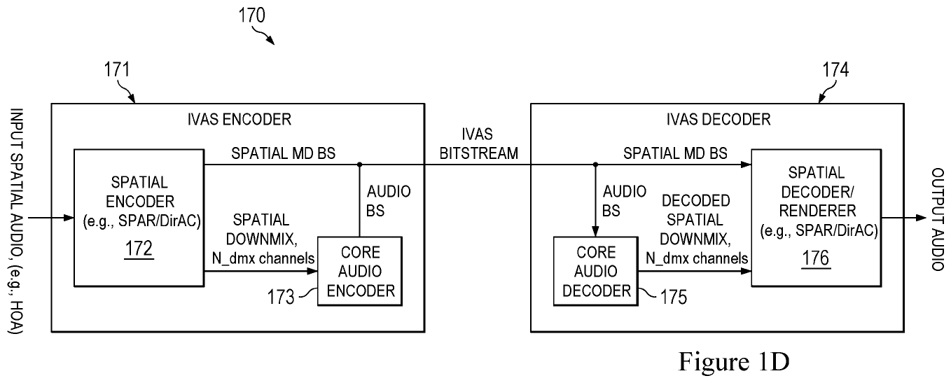

FIG. 1A is a block diagram that shows examples of components of an apparatus capable of implementing various aspects of this disclosure. As with other figures provided herein, the types and numbers of elements shown in FIG. 1A are merely provided by way of example. Other implementations may include more, fewer and/or different types and numbers of elements. According to some examples, the apparatus 101 may be, or may include, a device that is configured for performing at least some of the methods disclosed herein, such as a smart audio device, a laptop computer, a cellular telephone, a tablet device, a smart home hub, etc. In some such implementations the apparatus 101 may be, or may include, a server that is configured for performing at least some of the methods disclosed herein.

In this example, the apparatus 101 includes an interface system 105 and a control system 110. The interface system 105 may, in some implementations, be configured for providing a first set of HRTFs to the control system 110. In some examples, interface system 105 may be configured for outputting one or more results of the control system 110 processing the first set of HRTFs, such as a second set of HRTFs, a set of basis filters based on second set of HRTFs, audio data processed with one or more of the basis filters (such as left ear audio data and right ear audio data), etc.

The interface system 105 may include one or more network interfaces and/or one or more external device interfaces (such as one or more universal serial bus (USB) interfaces).

According to some implementations, the interface system 105 may include one or more wireless interfaces. The interface system 105 may include one or more devices for implementing a user interface, such as one or more microphones, one or more speakers, a display system, a touch sensor system and/or a gesture sensor system. In some examples, the interface system 105 may include one or more interfaces between the control system 110 and a memory system, such as the optional memory system 115 shown in FIG. 1A. However, the control system 110 may include a memory system in some instances.

The control system 110 may, for example, include a general purpose single- or multi-chip processor, a digital signal processor (DSP), an application specific integrated circuit (ASIC), a field programmable gate array (FPGA) or other programmable logic device, discrete gate or transistor logic, and/or discrete hardware components.

In some implementations, the control system 110 may reside in more than one device. For example, a portion of the control system 110 may reside in a device within an environment (such as a laptop computer, a tablet computer, a smart audio device, etc.) and another portion of the control system 110 may reside in a device that is outside the environment, such as a server. In other examples, a portion of the control system 110 may reside in a device within an environment and another portion of the control system 110 may reside in one or more other devices of the environment.

In some implementations, the control system 110 may be configured for performing, at least in part, the methods disclosed herein. According to some examples, the control system 110 may be configured for receiving a first set of HRTFs and for transforming the first set of HRTFs to a second set of HRTFs. The second set of HRTFs may be more efficiently approximated by a linear mixture than the first set of HRTFs, while preserving the psychoacoustic properties of the first set of HRTFs. In some such examples, the transforming may involve replacing delay components of the first set of HRTFs with all-pass filters in the second set of HRTFs. According to some such examples, the transforming may involve adjusting a phase response of each of the all-pass filters in the second set of HRTFs such that each inter-aural phase response is substantially linear for frequencies below an associated threshold frequency of the corresponding all-pass filter, and each phase response has reduced inter-aural phase difference for frequencies above the associated threshold frequency of the corresponding all-pass filter.

In some examples, the control system 110 may be configured for defining a set of basis filters based on the second set of HRTFs. The set of basis filters may have fewer members than the second set of HRTFs. In this context, a “member” of the second set of HRTFs is one of the HRTFs in the second set of HRTFs. Similarly, a “member” of the set of basis filters is one of the basis filters of the set of basis filters. According to some examples, the set of basis filters may have at least an order of magnitude fewer members than the second set of HRTFs. For example, the second set of HRTFs may have hundreds or thousands of members in some instances, whereas the set of basis filters may include fewer than 100 members, fewer than 50 members, or even fewer than 20 members.

According to some examples, the control system 110 may be configured for receiving, via the interface system 105, a bitstream of input audio data in an input audio format. The input audio format may, for example, be an Ambisonic audio format, an audio object-based audio format (such as Dolby Atmos™), a channel-based audio format, etc. In some examples, the control system 110 may be configured for combining the input audio data with one or more basis filters of the set of basis filters to produce left audio data and right audio data, such as left ear audio data and right ear audio data. In some such examples, the control system 110 may be configured for outputting, via the interface system 105, the left audio data and the right audio data. Outputting the left audio data and the right audio data may involve storing the left audio data and the right audio data, transmitting the left audio data and the right audio data, providing the left audio data and the right audio data to a set of loudspeakers for playback, providing the left audio data and the right audio data for further processing, or combinations thereof.

In some examples, the control system 110 may be configured for implementing at least part of a codec for Immersive Voice and Audio Services (IVAS). Some examples are described herein with reference to FIG. 23.

Some or all of the methods described herein may be performed by one or more devices according to instructions (e.g., software) stored on one or more non-transitory media. Such non-transitory media may include memory devices such as those described herein, including but not limited to random access memory (RAM) devices, read-only memory (ROM) devices, etc. The one or more non-transitory media may, for example, reside in the optional memory system 115 shown in FIG. 1A and/or in the control system 110. Accordingly, various innovative aspects of the subject matter described in this disclosure can be implemented in one or more non-transitory media having software stored thereon. The software may, for example, include instructions for controlling at least one device to process audio data. The software may, for example, be executable by one or more components of a control system such as the control system 110 of FIG. 1A.

In some examples, the apparatus 101 may include the optional microphone system 120 shown in FIG. 1A. The optional microphone system 120 may include one or more microphones. In some implementations, one or more of the microphones may be part of, or associated with, another device, such as a speaker of the speaker system, a smart audio device, etc.

According to some implementations, the apparatus 101 may include the optional loudspeaker system 125 shown in FIG. 1A. The optional loudspeaker system 125 may include one or more loudspeakers. Loudspeakers may sometimes be referred to herein as “speakers.” In some examples, at least some loudspeakers of the optional loudspeaker system 125 may be arbitrarily located. For example, at least some speakers of the optional loudspeaker system 125 may be placed in locations that do not correspond to any standard prescribed speaker layout, such as Dolby 5.1, Dolby 5.1.2, Dolby 7.1, Dolby 7.1.4, Dolby 9.1, Hamasaki 22.2, etc. In some such examples, at least some loudspeakers of the optional loudspeaker system 125 may be placed in locations that are convenient to the space (e.g., in locations where there is space to accommodate the loudspeakers), but not in any standard prescribed loudspeaker layout.

In some implementations, the apparatus 101 may include the optional sensor system 130 shown in FIG. 1A. The optional sensor system 130 may include a touch sensor system, a gesture sensor system, one or more cameras, etc.

In some implementations, the apparatus 101 may include the optional display system 135 shown in FIG. 1A. The optional display system 135 may include one or more displays, such as one or more light-emitting diode (LED) displays. In some instances, the optional display system 135 may include one or more organic light-emitting diode (OLED) displays. In some examples wherein the apparatus 101 includes the display system 135, the sensor system 130 may include a touch sensor system and/or a gesture sensor system proximate one or more displays of the display system 135. According to some such implementations, the control system 110 may be configured for controlling the display system 135 to present a graphical user interface (GUI), such as a GUI related to implementing one of the methods disclosed herein.

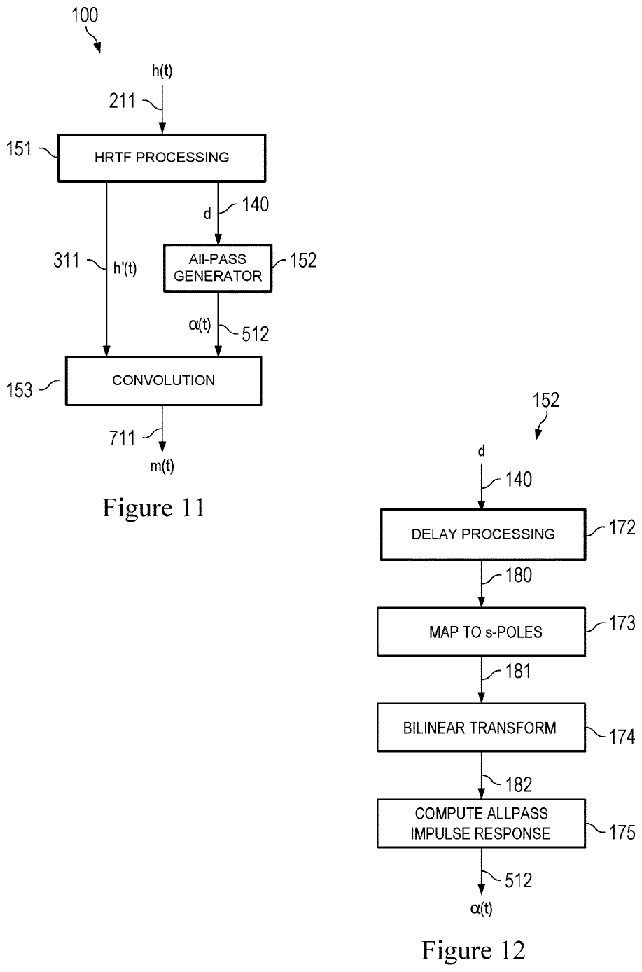

FIG. 1B illustrates a schematic block diagram of an example device architecture 101 (in this example, an apparatus 101) that may be used to implement various aspects of the present disclosure. The apparatus 101 of FIG. 1B is an instance of the apparatus 101 of FIG. 1A. Architecture 101 includes but is not limited to servers and client devices, systems, etc., which may be configured to perform the methods that are described with reference to any or all of FIGS. 11-17 and 21. As shown, the architecture 101 includes central processing unit (CPU) 141, which is capable of performing various processes in accordance with a program stored in, for example, read only memory (ROM) 142 or a program loaded from, for example, storage unit 148 to random access memory (RAM) 143. The CPU 141 may be, for example, an electronic processor 141. In these examples, the CPU 141 is an instance of the control system 110 of FIG. 1A and the ROM 142 and RAM 143 are instances of the memory system 115. In RAM 143, the data required when CPU 141 performs the various processes is also stored, as required. CPU 141, ROM 142, and RAM 143 are connected to one another via bus 144. Input/output (I/O) interface 145 is also connected to bus 144. The bus 144 and the I/O) interface 145 are instances of the interface system 105 of FIG. 1A.

The following components are connected to I/O interface 145: input unit 146, that may include a keyboard, a mouse, or the like; output unit 147 that may include a display such as a liquid crystal display (LCD) and one or more speakers; storage unit 148 including a hard disk, or another suitable storage device; and communication unit 149 including a network interface card such as a network card (e.g., wired or wireless).

In some implementations, input unit 146 includes one or more microphones in different positions (depending on the host device) enabling capture of audio signals in various formats (e.g., mono, stereo, spatial, immersive, and other suitable formats).

In some implementations, output unit 147 include systems with various number of speakers. Output unit 147 (depending on the capabilities of the host device) can render audio signals in various formats (e.g., mono, stereo, immersive, binaural, and other suitable formats).

In some embodiments, communication unit 149 is configured to communicate with other devices (e.g., via a network). Drive 150 is also connected to I/O interface 145, as required. Removable medium 151, such as a magnetic disk, an optical disk, a magneto-optical disk, a flash drive or another suitable removable medium is mounted on drive 150, so that a computer program read therefrom is installed into storage unit 148, as required. A person skilled in the art would understand that although apparatus 101 is described as including the above-described components, in real applications, it is possible to add, remove, and/or replace some of these components and all these modifications or alteration all fall within the scope of the present disclosure.

In accordance with example embodiments of the present disclosure, the processes described above may be implemented as computer software programs or on a computer-readable storage medium. For example, embodiments of the present disclosure include a computer program product including a computer program tangibly embodied on a machine readable medium, the computer program including program code for performing methods. In such embodiments, the computer program may be downloaded and mounted from the network via the communication unit 149, and/or installed from the removable medium 151, as shown in FIG. 1B.

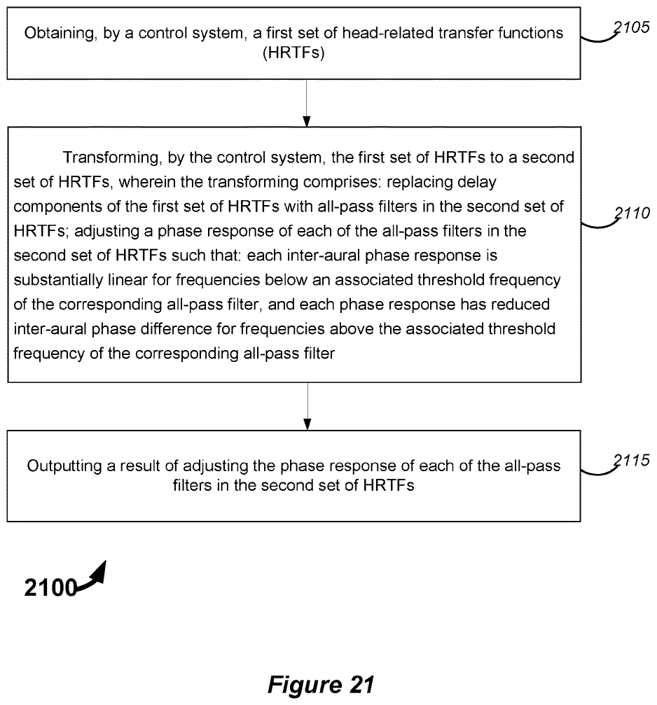

FIG. 1C illustrates a schematic block diagram of an example CPU 141 implemented in the device architecture 101 of FIG. 1B that may be used to implement various aspects of the present disclosure. The CPU 141 includes an electronic processor 160 and a memory 161. The electronic processor 160 is electrically and/or communicatively connected to the memory 161 for bidirectional communication. The memory 161 stores encoding software 162 and decoding software 163. The memory 161 may be, for example, a ROM, a RAM, or another non-transitory computer readable medium. The electronic processor 160 may implement the encoding software 162 stored in the memory 161 to perform, among other things, the method 2100 of FIG. 21. Additionally, the electronic processor 160 may implement the decoding software 163 stored in the memory 161 to perform, among other things, the methods that are described with reference to any or all of FIGS. 11-17 and 21.

Generally, various example embodiments of the present disclosure may be implemented in hardware or special purpose circuits (e.g., control circuitry), software, logic or any combination thereof. For example, the units discussed above can be executed by control circuitry (e.g., CPU 141 in combination with other components of FIG. 1B), thus, the control circuitry may be performing the actions described in this disclosure. Some aspects may be implemented in hardware, while other aspects may be implemented in firmware or software which may be executed by a controller, microprocessor or other computing device (e.g., control circuitry). While various aspects of the example embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

Additionally, various blocks shown in the flowcharts may be viewed as method steps, and/or as operations that result from operation of computer program code, and/or as a plurality of coupled logic circuit elements constructed to carry out the associated function(s). For example, embodiments of the present disclosure include a computer program product including a computer program tangibly embodied on a machine readable medium, the computer program containing program codes configured to carry out the methods as described above.

In the context of the disclosure, a machine-readable medium may be any tangible medium that may contain or store a program for use by or in connection with an instruction execution system, apparatus, or device. The machine-readable medium may be a machine-readable signal medium or a machine-readable storage medium. A machine-readable medium may be non-transitory and may include but not limited to an electronic, magnetic, optical, electromagnetic, infrared, or semiconductor system, apparatus, or device, or any suitable combination of the foregoing. More specific examples of the machine-readable storage medium would include an electrical connection having one or more wires, a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Computer program code for carrying out methods of the present disclosure may be written in any combination of one or more programming languages. These computer program codes may be provided to a processor of a general-purpose computer, special purpose computer, or other programmable data processing apparatus that has control circuitry, such that the program codes, when executed by the processor of the computer or other programmable data processing apparatus, cause the functions/operations specified in the flowcharts and/or block diagrams to be implemented. The program code may execute entirely on a computer, partly on the computer, as a stand-alone software package, partly on the computer and partly on a remote computer or entirely on the remote computer or server or distributed over one or more remote computers and/or servers.

### Example IVAS Codec Framework

FIG. 1D is a block diagram of an immersive voice and audio services (IVAS) coder/decoder (“codec”) framework 170 for encoding and decoding IVAS bitstreams, according to one or more embodiments. IVAS is expected to support a range of audio service capabilities, including but not limited to mono to stereo upmixing and fully immersive audio encoding, decoding and rendering. IVAS is also intended to be supported by a wide range of devices, endpoints, and network nodes, including but not limited to: mobile and smart phones, electronic tablets, personal computers, conference phones, conference rooms, virtual reality (VR) and augmented reality (AR) devices, home theatre devices, and other suitable devices.

In this example, the IVAS codec 170 includes IVAS encoder 171 and IVAS decoder 174. In some examples, the IVAS encoder 171, the IVAS decoder 174, or both, may be implemented by one or more instances of the control system 110 of FIG. 1A, by the CPU 141 of FIGS. 1B and 1C, etc. In some examples, the IVAS encoder 171 may be implemented by the encoding software 162 of FIG. 1C and the IVAS decoder 174 may be implemented by the decoding software 163 of FIG. 1C. According to some examples, a control system that implements the IVAS encoder 171, the IVAS decoder 174, or both, also may be configured to perform some or all of the operations disclosed herein, such as the methods that are described with reference to one or more of FIGS. 11-17 and 21.

According to this example, the IVAS encoder 171 includes spatial encoder 172 that receives N channels of input spatial audio (e.g., FOA, HOA). In some implementations, spatial encoder 172 may be configured to implement Spatial Reconstruction (SPAR), Directional Audio Coding (DirAC), another spatial audio coding technology, or combinations thereof. In this example, the output of spatial encoder 172 includes a spatial metadata (MD) bitstream (BS) and N_dmx channels of spatial downmix. According to this example, the spatial MD is quantized and entropy coded. In some implementations, quantization can include fine, moderate, coarse and extra coarse quantization strategies and entropy coding can include Huffman or Arithmetic coding. In some implementations, the framework may permit not more than 3 levels of quantization at a given operating mode; however, with decreasing bitrates, in some such implementations the three levels become increasingly coarser overall, to meet bitrate requirements. According to this example, the core audio encoder 173—which may, for example, be based on a mono Enhanced Voice Services (EVS) encoding unit)—is configured to encode N_dmx channels (N_dmx=1-16 channels) of the spatial downmix into an audio bitstream, which is combined with the spatial MD bitstream into an IVAS encoded bitstream transmitted to IVAS decoder 174.

In this example, the IVAS decoder 174 includes core audio decoder 175 (e.g., EVS decoder) that decodes the audio bitstream extracted from the IVAS bitstream to recover the N_dmx audio channels. According to this example, the spatial decoder/renderer 176 (e.g., SPAR/DirAC) decodes the spatial MD bitstream extracted from the IVAS bitstream to recover the spatial MD, and synthesizes/renders output audio channels using the spatial MD and a spatial upmix for playback on various audio systems with different speaker configurations and capabilities.

FIG. 1E shows an example of a coordinate system with reference to a listener's head. Head Related Transfer Function (HRTF) filters may be used to process audio signals to produce binaural audio signals, so as to provide a listener with the illusion of sounds arriving from prescribed directions of arrival. A direction of arrival may be defined in terms of an (x, y, z) unit vector, where the Cartesian coordinates may be defined as shown in FIG. 1E. According to the example shown in FIG. 1E, a coordinate frame is located with its origin approximately at the center of the listener's head 200, with the X axis 801 pointing forward (in the direction of the listener's nose), the Y axis 802 pointing to the listener's left, and the Z axis 803 pointing upward through the top of the listener's head.

An audio signal, s(t), may be processed using HRTF filters, to provide a listener with the illusion of the sound (of the signal s(t)) arriving from the directions of arrival defined by the unit-vector (x, y, z). This process produces the two ear signals, eₗ(t) and eᵣ(t), by convolving the input audio signal with each of a pair of HRTF filters (hₗ(t) and hᵣ(t)):

$${e}_{l} ( t ) = {h}_{l} ( t ) ⊗ s ( t ) \qquad ( 2 )$$

$${e}_{r} ( t ) = {h}_{r} ( t ) ⊗ s ( t )$$

The HRTF filters (hₗ(t) and hᵣ(t)) may be derived from the direction vector (x, y, z), according to:

$$( {h}_{l} ( t ) , {h}_{r} ( t ) ) ← \text{?} ( x , y , z ) \qquad ( 3 )$$

[symbol] (x, y, z) is referred herein as an HRTF set function, since this function is suitable for computing HRTF filters for a set of (x, y, z) direction vectors. The set of (x, y, z) vectors for which the HRTF set function produces valid HRTF filters is referred herein as the domain of the HRTF set function.

In the explanation given below, time-domain impulse responses are used to represent filter responses. It will be appreciated by those skilled in the art that equivalent storage and manipulation of filter responses may be carried out in other domains, including but not limited to the frequency domain.

An HRTF set function may be used to create an HRTF discrete library, that defines the left and right ear HRTF responses for a set of N (x, y, z) unit-vectors:

$$HRTFLib = ( \begin{matrix}{x}_{1} & {y}_{1} & {z}_{1} & \text{?} ( {x}_{1} , {y}_{1} , {z}_{1} ) \\ {x}_{2} & {y}_{2} & {z}_{2} & \text{?} ( {x}_{2} , {y}_{2} , {z}_{2} ) \\ ⋮ & ⋮ & ⋮ & ⋮ \\ {x}_{N} & {y}_{N} & {z}_{N} & \text{?} ( {x}_{N} , {y}_{N} , {z}_{N} )\end{matrix} ) \qquad ( 4 )$$

And when the HRTF set functions are evaluated in Equation 4, the HRTF discrete library may be written as:

$$HRTFLib = ( \begin{matrix}{x}_{1} & {y}_{1} & {z}_{1} & {h}_{l , 1} & {h}_{r , 1} \\ {x}_{2} & {y}_{2} & {z}_{2} & {h}_{l , 2} & {h}_{r , 2} \\ ⋮ & ⋮ & ⋮ & ⋮ & ⋮ \\ {x}_{N} & {y}_{N} & {z}_{N} & {h}_{l , N} & {h}_{r , N}\end{matrix} ) \qquad ( 5 )$$

It is desired to be able to provide a means for defining an HRTF set function, whereby each output HRTF filter produced by the HRTF set function is formed from a linear combination of basis filters. A linear HRTF set function may be defined according to Equation 6, where eₗ(t) and eᵣ(t) filters are computed as:

$${e}_{l} ( t ) = {\sum }_{k = 1}^{K} {g}_{k}^{l} ( x , y , z ) {b}_{k}^{l} ( t ) \qquad ( 6 )$$

$${e}_{r} ( t ) = {\sum }_{k = 1}^{K} {g}_{k}^{r} ( x , y , z ) {b}_{k}^{r} ( t )$$

Accordingly to Equation 6, a set of K left-ear basis filters,

$${b}_{k}^{l} ( t ) ,$$

and K right-ear basis filters

$${b}_{k}^{r} ( t ) ,$$

are linearly combined with weights defined by the gain functions

$${ℊ}_{k}^{l} ( x , y , z ) and {ℊ}_{k}^{r} ( x , y , z ) .$$

In an alternative embodiment, a symmetric HRTF set function may be defined (wherein the left-ear HRTF filter for the direction (x, y, z) is identical to the right ear HRTF for direction (x, −y, z)), using a smaller set of basis filters and gains functions:

$${e}_{l} ( t ) = {\sum }_{k = 1}^{K} {g}_{k} ( x , y , z ) {b}_{k} ( t ) \qquad ( 7 )$$

$${e}_{r} ( t ) = {\sum }_{k = 1}^{K} {g}_{k} ( x , - y , z ) {b}_{k} ( t )$$

Without loss of generality, we may examine the first line of Equation 7, with the understanding that the explanation following will apply equally well to the second line of Equation 7 and/or to Equation 6.

For a set of N directions of arrival ((xₙ, yₙ, zₙ), n=1 . . . . N), we may re-write the first line of Equation 7 in matrix form (also omitting the l subscript from e (t) in order to simplify the equation):

$$( \begin{matrix}{e}_{1} ( t ) \\ {e}_{2} ( t ) \\ ⋮ \\ {e}_{N} ( t )\end{matrix} ) = ( \begin{matrix}{ℊ}_{1} ( {x}_{1} , {y}_{1} , {z}_{1} ) & {ℊ}_{2} ( {x}_{1} , {y}_{1} , {z}_{1} ) & ⋯ & {ℊ}_{K} ( {x}_{1} , {y}_{1} , {z}_{1} ) \\ {ℊ}_{1} ( {x}_{2} , {y}_{2} , {z}_{2} ) & {ℊ}_{2} ( {x}_{2} , {y}_{2} , {z}_{2} ) & ⋯ & {ℊ}_{K} ( {x}_{2} , {y}_{2} , {z}_{2} ) \\ ⋮ & ⋮ & ⋱ & ⋮ \\ {ℊ}_{1} ( {x}_{N} , {y}_{N} , {z}_{N} ) & {ℊ}_{2} ( {x}_{N} , {y}_{N} , {z}_{N} ) & ⋯ & {ℊ}_{K} ( {x}_{N} , {y}_{N} , {z}_{N} )\end{matrix} ) \times ( \begin{matrix}{b}_{1} ( t ) \\ {b}_{2} ( t ) \\ ⋮ \\ {b}_{K} ( t )\end{matrix} ) \qquad ( 8 )$$

We may rewrite Equation 8 in simpler form, as:

$$E ( t ) = G \times B ( t ) \qquad ( 9 )$$

In Equation 9, the column vector E(t) defines a set of N left-ear HRTF filter responses for the N unit vectors ((xₙ, yₙ, zₙ), n=1 . . . . N), and the column vector B(t) defines a set of K filter responses. In some embodiments, a goal is to determine the filter responses, B(t), such that the resulting HRTF filters, E(t) are a close approximation to an original set of HRTF filter responses, E_{orig}(t).

Various methods are known for determining suitable filters, B(t), and one example is found according to:

$$B ( t ) = {G}^{+} \times {E}_{ori ℊ} ( t ) \qquad ( 10 )$$

where G⁺ refers to the pseudo-inverse of the matrix G (as defined in Equation 9).

It will be appreciated that other methods may be employed, where the goal of each method may be to minimize the magnitude of the difference, E(t)−E_{orig}(t).

A very large number(K) of basis filters may be required in order to provide a reasonable approximation (E(t)≈E_{orig}(t)). The difficulty with the use of a linear mixing process (as per Equations 6, 7 or 8) is that the high-frequency components of HRTF filters may generally be very difficult to define in terms of linear mixtures.

In some embodiments, the set of original HRTF filters, E_{orig}(t), are modified to produce a set of modified HRTF filters, E_{mod}(t), where the modified HRTF filters differ from the original filter in their phase-response at high frequencies. For each of the N directions, we may define the frequency response of the original HRTF and the modified HRTF using the Fourier transform:

$$\begin{matrix}{R}_{ori ℊ , n} ( f ) = ℱ \{ {E}_{ori ℊ , n} ( t ) \} \\ {R}_{m o d , n} ( f ) = ℱ \{ {E}_{mod , n} ( t ) \}\end{matrix} \qquad ( 11 )$$

The frequency response functions R_{orig,n}(f) and R_{mod,n}(f) are complex valued, and hence we may then say that:

$$\begin{matrix}{R}_{ori ℊ , n} ( f ) \approx {R}_{m o d , n} ( f ) & when f \leq {F}_{p} \\ \vert {R}_{ori ℊ , n} ( f ) \vert \approx \vert {R}_{m o d , n} ( f ) \vert & when f > {F}_{p}\end{matrix} \qquad ( 12 )$$

so that the modified filter closely matches the original for frequencies less than Fₚ Hz, and the magnitude of the modified filter closely matches the original at higher frequencies. In various non-limiting examples, the transition frequency, Fₚ, may be equal to about 1200 Hz, and may generally lie within a range, for example: 1000 Hz≤Fₚ<3000 Hz. In some applications, it may be desired to reduce the number (K) of basis functions and it may be necessary to allow the value of Fₚ to be less than 1000 Hz, for example 950 Hz, 900 Hz, 850 Hz, 800 Hz, 750 Hz, 700 Hz, 650 Hz, 600 Hz, 550 Hz, or as low as 500 Hz. In other example applications, the transition frequency may be in another range, greater than 3000 Hz, such as for example 3050 Hz, 3100 Hz, 3150 Hz, 3200 Hz, 3250 Hz, 3300 Hz, etc.

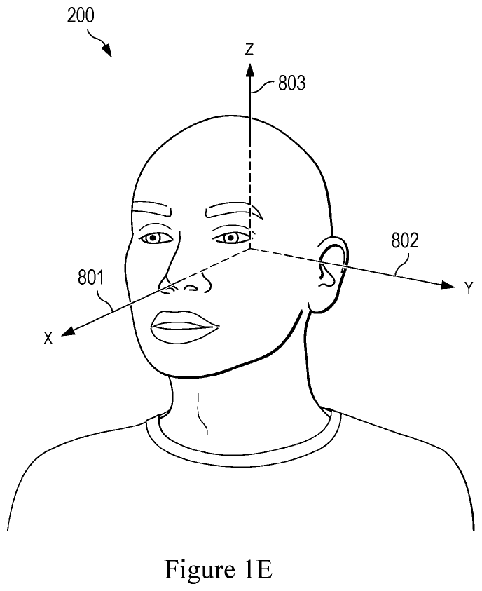

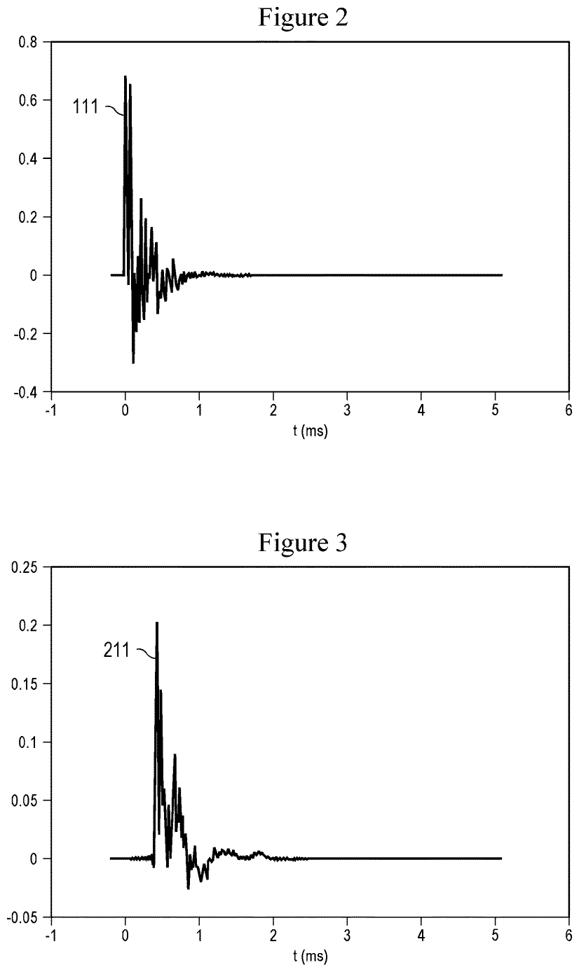

FIGS. 2, 3 and 4 show examples of impulse responses of HRTF filters. FIG. 2 shows the impulse response 111 of a left ear HRTF filter, for the direction of arrival:

$$( x , y , z ) = ( \frac{1}{\sqrt{2}} , \frac{1}{\sqrt{2}} , 0 )$$

(being a direction in the front-left). Likewise, FIG. 3 shows the impulse response 211 of the right ear HRTF for the same direction of arrival. It will be seen, from examination of FIG. 3, that impulse response 211 includes a delay of 0.4 ms.

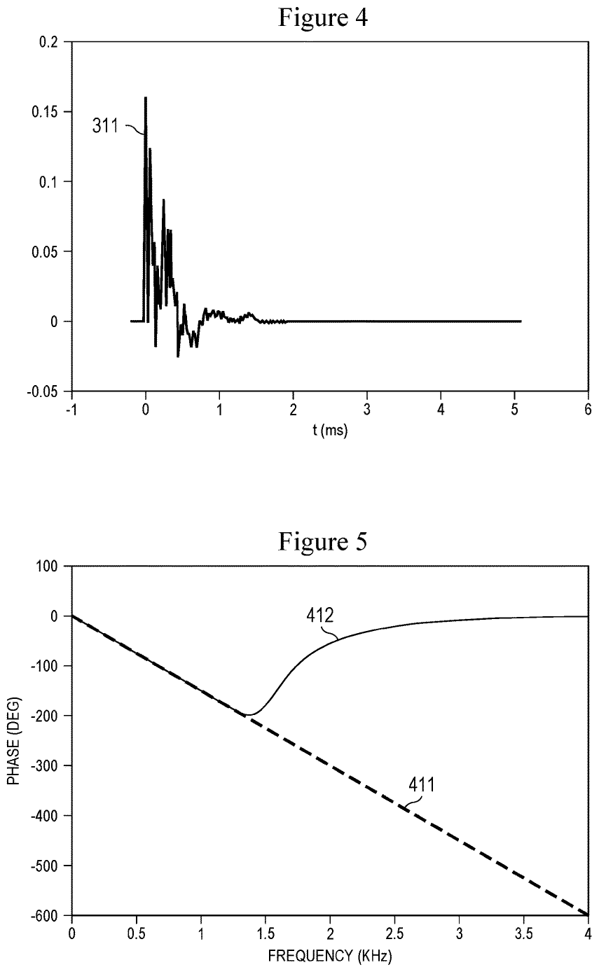

FIG. 4 shows the (delay-less) impulse response 311 that is created by removing the 0.4 ms delay from the impulse response 211 of FIG. 3. FIG. 5 shows examples of graphs that indicate phase response versus frequency. The 0.4 ms delay of FIG. 3 may also be defined as a linear phase response plot 411 in FIG. 5. In addition, an alternative phase response 412 is plotted in FIG. 5, whereby this alternative phase curve 412 matches closely to the linear phase response 411 for frequencies between 0 and 1400 Hz.

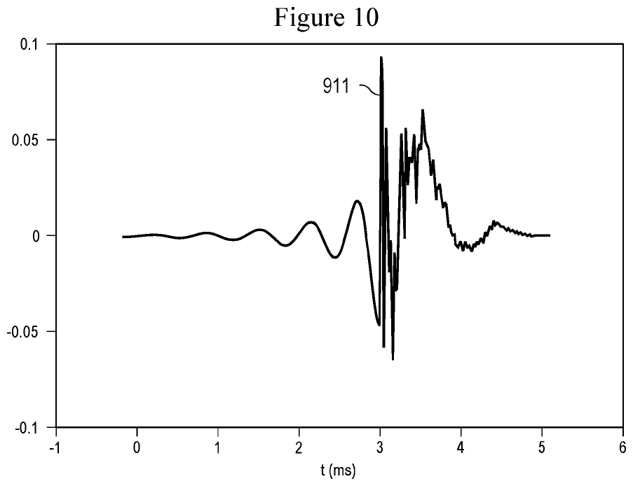

In some embodiments, the original impulse response 211 of FIG. 3 may be modified by removing the bulk delay of 0.4 ms, to produce the delay-less impulse response 311 of FIG. 4, and the phase response 412 of FIG. 5 may be applied to the impulse response 311 to produce a new filter impulse response that possesses the correct phase response for frequencies below 1400 Hz. Unfortunately, this may result in a new impulse response that is not causal, since in order for this filter to be implemented in a real-time audio process, an additional delay of 3 ms may be added to produce the impulse response: see, for example, the impulse response 911 shown in FIG. 10. In order to maintain compatibility with the right ear response, this example impulse response 111 (the left ear response) will also require a 3 ms delay to be added, resulting in the impulse response 811 of FIG. 9.

Some disclosed examples involve modifying the original HRTF filters, for both left and right ears, to provide an inter-aural phase difference that is similar to that shown in the phase response 412 of FIG. 5, without the side effect of an undesired delay (e.g., the 3 ms delay discussed above with reference to FIGS. 9 and 10).

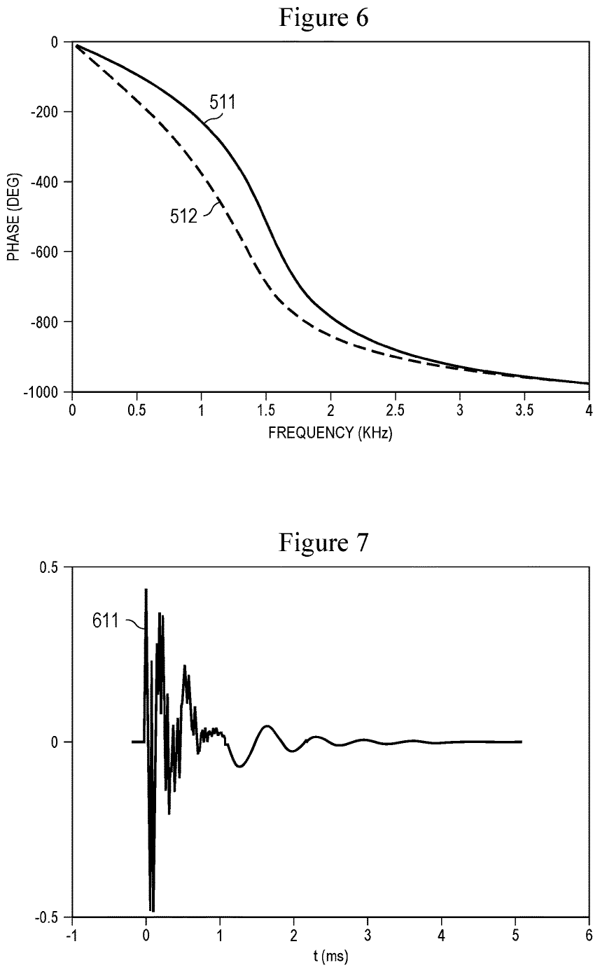

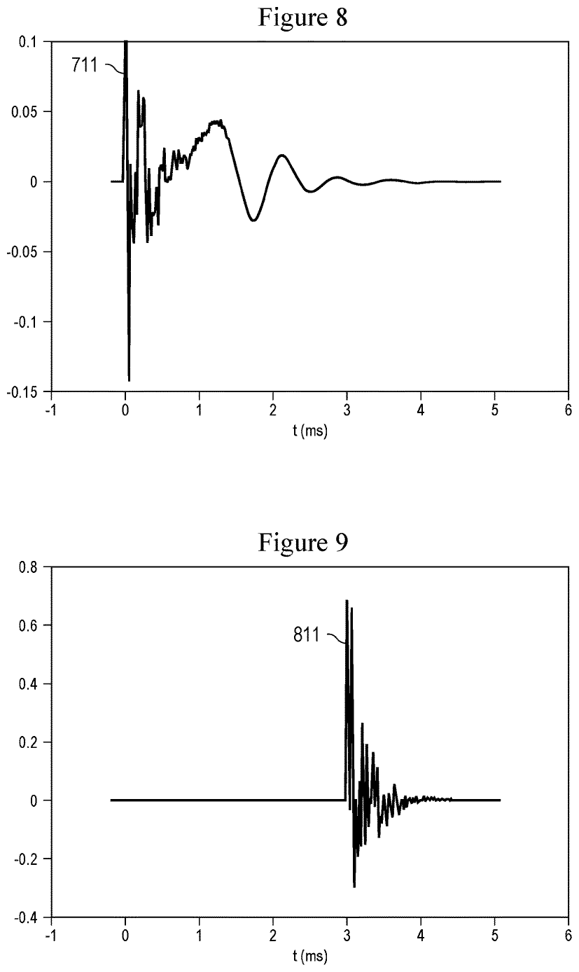

FIG. 6 shows examples of causal all-pass filters. FIGS. 7 and 8 show examples of modified HRTFs that may be produced by causal all-pass filters. In some embodiments, the causal all-pass filters 511 and 512 of FIG. 6 may be applied to the original left and right ear impulse responses 111 and 311, respectively, to produce the modified left ear HRTF 611 of FIG. 7 and the modified right ear HRTF 711 of FIG. 8, respectively.

FIG. 11 shows examples of HRTF processing blocks. According to some examples, the blocks of FIG. 11 may be implemented by the control system 110 of FIG. 1A, e.g., according to instructions stored on computer-readable media. In FIG. 11, the arrangement 100 shows an original HRTF impulse response 211, h(t), received and processed by HRTF processing block 151 to determine the bulk delay 140, d, being the delay inherent in the impulse response 211. According to this example, the HRTF processing block 151 also produces the delay-less HRTF 311, h′(t), such that h′(t)=h(t+d).

In the example shown in FIG. 11, the all-pass generator 152 produces an all-pass filter impulse response 512, α(t), in response to the delay 140, d, and the convolution process 153 combines the delay-less impulse-response 311 and all-pass response 512 to produce the modified HRTF 711, m(t).

All-pass filter 512, α(t), may be defined as a function such as the following:

$$α ( t ) = \text{?} ( d , t ) \qquad ( 13 )$$

where the function [symbol] (d, t) defines the operation of all-pass generator 152. We are interested in the phase-response of [symbol] (d, t):

$$Φ ( f , d ) = arg ( ℱ \{ \text{?} ( d , t ) \} ( f ) ) \qquad ( 14 )$$

where Φ(f, d) represents the phase response at frequency f of the all-pass filter that is produced by the all-pass generator 152 for the delay value, d.

Let us define Φ₀(t)=arg( [symbol] { [symbol] (0,t)}(f)), being the all-pass phase response produced by the all-pass generator 152 when the delay d=0. We may refer to this as the zero-delay all-pass. In some embodiments, we may require the all-pass phase response to satisfy:

$$Φ ( f , d ) - {Φ}_{0} ( t ) \approx - 2 π fd for 0 \leq f \leq {F}_{p} and 0 \leq d \leq {d}_{max} \qquad ( 15 )$$

The left side of Equation 15 represents the phase difference between the zero-delay all-pass and the all-pass filter defined for delay d. This phase difference is equivalent to the phase response 412 of FIG. 5. The right side of Equation 15 represents the linear-phase ramp that is expected for a delay d. This is equivalent to the linear phase response 411 of FIG. 5.

Equation 15 is therefore expressing the requirement that, in this example, the all-pass phase-response 412 should match the linear-ramp phase response 411, for frequencies up to Fₚ. In addition, Equation 15 defines an upper-bound, dₘₐₓ, to the range of delay values over which the all-pass generator function, [symbol] (d, t), is expected to produce valid results. A typical value for dₘₐₓ is dₘₐₓ=0.7 ms (milliseconds), but in some applications dₘₐₓ may be some other value, such as a value between 0.6 ms and 0.8 ms, a value between 0.5 ms and 0.8 ms, a value between 0.6 ms and 0.9 ms, a value between 0.5 ms and 1.0 ms, etc.

In some embodiments, a finite set of M delay values (d₁, d₂, . . . , d_{M}) may be chosen, spanning the range from 0 to dₘₐₓ, and suitable all-pass responses (α₁(t), α₂, . . . (t), α_{M}(t)) may be pre-computed according to an optimization process. In this case, the all-pass generator function, [symbol] (d, t), may be implemented by a look-up table or an interpolation function, by utilising the M pre-stored all-pass responses.

In some further embodiments, each of the all-pass responses (for example, the m^{th} all-pass filter, α_{M}(t)) may be defined as an infinite impulse response (IIR)) filter with T conjugate pole-pairs and their corresponding conjugate zero pairs. A base set of T filter poles, p_{1,m}, p_{2,m}, . . . , d_{T,m} may be chosen, and the filter α_{M}(t) may then be defined as an all-pass filter with poles

$$( {p}_{1 , m} , \overline{{p}_{1 , m}} , {p}_{2 , m} , \overline{{p}_{2 , m}} , … , {p}_{T , m} , \overline{{p}_{T , m}} ) \text{} and \\ zeros ( \frac{1}{{p}_{1 , m}} , \frac{1}{\overline{{p}_{1 , m}}} , \frac{1}{{p}_{2 , m}} , \frac{1}{\overline{{p}_{2 , m}}} , … , \frac{1}{{p}_{T , m}} , \frac{1}{\overline{{p}_{T , m}}} ) .$$

Hence, when the base set of all M all-pass responses (α₁(t), α₂, . . . (t), α_{M}(t)) are defined as IIR filters of order 2T, the set of M all-pass responses are fully defined in terms of the [T×M] complex base poles:

$$P = ( \begin{matrix}{p}_{1 , 1} & {p}_{2 , 2} & ⋯ & {p}_{1 , M} \\ {p}_{2 , 1} & {p}_{2 , 2} & ⋯ & {p}_{2 , M} \\ ⋮ & ⋮ & ⋱ & ⋮ \\ {p}_{T , 1} & {p}_{T , 2} & ⋯ & {p}_{T , M}\end{matrix} ) ∈ {ℂ}^{T \times M} \qquad ( 16 )$$

The complex values of the matrix, P, in Equation 16 may be derived by an optimisation process, such as the MATLAB FMINSEARCH function. The optimization process may, in some examples, be guided by a cost function—also referred to herein as an error function—that first computes the all-pass filters (α₁(t), α₂, . . . (t), α_{M}(t)) from the base poles in the matrix P, then computes the corresponding phase responses (Φ₁(f), Φ₂(f), . . . , Φ_{M}(f)) according to Equation 14 and then measures how well the relative phase difference between all pairs of all-pass filters matches the expected delay difference. For example, the error function may be defined as:

$$err ( P ) = {Σ}_{{m}_{1} = 1}^{M} {Σ}_{{m}_{2} = 1}^{M} {\int }_{f = 0}^{{F}_{p}} {( {Φ}_{{m}_{1}} ( f ) - {Φ}_{{m}_{2}} ( t ) + 2 π f ( {d}_{1} - {d}_{2} ) )}^{2} df \qquad ( 17 )$$

Given a matrix, P, of base poles representing the set of M all-pass filters (with T complex base poles for each all-pass filter), and given the corresponding set of delay values (d₁, d₂, . . . , d_{M}), a polynomial approximation may be formed, so that the base poles may be defined as a polynomial function of d. This polynomial approximation process may be implemented according to known methods, including but not limited to the MATLAB POLYFIT function.

In some embodiments, the number of complex base poles is T=3, and a polynomial of order 4 may be used to compute the base pole values as a function of the delay d. According to this embodiment, the process for computing an all-pass filter, α(t) is carried out by the following sequence of operations:
1. Given the delay, d, compute the base poles, (p₁, p₂, p₃) according to:

$${p}_{t} = {c}_{1 , t} + {c}_{2 , t} d + {c}_{3 , t} {d}^{2} + {c}_{4 , t} {d}^{3} + {c}_{5 , t} {d}^{4}$$

2. Form an IIR filter with poles: p₁, p₁,p₂, p₂,p₃, p₃, and corresponding zeros:

$$\frac{1}{{p}_{1}} , \frac{1}{\overline{{p}_{1}}} , \frac{1}{{p}_{2}} , \frac{1}{\overline{{p}_{2}}} , \frac{1}{{p}_{3}} , \frac{1}{\overline{{p}_{3}}}$$

3. Compute the impulse response of the IIR filter, to form the all-pass response, α(t)

The three steps shown above show the use of polynomial functions as a convenient way to compute the poles of a filter. Of course, a polynomial may only give an approximation to the “best” poles, and it is known that small errors in the pole locations may result in large changes in the resulting filter response. Some alternative methods involve applying a non-linear function (such as Equation 18) to the polynomial values (Jₗ and Jₗ₊₁). This non-linear function may be defined so that small errors in the polynomial values (Jₗ and Jₗ₊₁) will no longer result in large errors in the pole locations. Furthermore, some such example involve computing the pole locations in the “s-domain” and then mapping them to the “z-domain.” According to some examples, this mapping may be implemented using the MATLAB function “bilinear”. Other choices of non-linear mapping functions may be used, and such non-linear mapping functions may produce poles in the z-domain, the s-domain or other domains.

FIG. 12 shows additional transformation processes that may be implemented by the all-pass generator 152 of FIG. 11 according to some embodiments. In the example shown in FIG. 12, the all-pass generator 152 receiving a chosen delay, d, 140, which is processed by delay processing block 172 to produce a set of intermediate values 180. In this example, the intermediate values 180 are then mapped by additional non-linear processing to form a set of filter poles 182. Filter poles 182 are then processed by all-pass computation block 175 to form the all-pass impulse response α(t), 512, of FIGS. 11 and 12.

According to some examples that correspond to the blocks shown in FIG. 12, the delay processing block 172 applies an above-described polynomial function to output a set of intermediate values 180, which may be the set of numbers: J₁ in some examples. In some such examples, the mapping block 173 applies a non-linear mapping process to the set of intermediate values 180, for example by implementing Equation 18, to produce the output 181, which are s-domain pole locations in one example. In some examples, the bilinear transform block 174 convert the s-domain pole locations to produce the output 182, which includes z-domain pole locations in one example. In the example shown in FIG. 12, the all-pass computation block 175 computes the output 512, which is alpha(t) (an impulse response) in this example. In alternative examples, the output 512 may be a phase response, a frequency response, or the output of whatever other method we may use to define the all-pass filter response.

When a simple function, such as a polynomial, is used to produce the filter poles, small inaccuracies in the polynomial outputs may translate into large errors in the final all-pass response when the poles are very close to the unit-circle, as will be appreciated by those skilled in the art. Non-linear processing, as applied in FIG. 12 to transform intermediate values, 180, into filter poles, 182, may enable the processing, 172, to be implemented more efficiently.

In some embodiments, the processing 172 is implemented as a set of L polynomial functions that produce L intermediate values, 180. For example, Jₗ=Polyₗ(d) (l∈1 . . . . L). Intermediate values, 180, may then be used to generate, by filter pole generating block 173 in this example, s-plane filter poles, 181. For example, two intermediate values, Jₗ and Jₗ₊₁ may be used to define a complex s-plane pole, Pₙ:

$${P}_{n} = - 2 π {J}_{l} exp ( i \frac{2 {tan}^{- 1} ( {J}_{l + 1} ) + π}{4} ) \qquad ( 18 )$$

Alternately, a single intermediate value, e.g. Jₗ, may be used by filter pole generating block 173 to define a single real s-plane pole, Pₙ, according to Pₙ=−2πJₗ.

The s-plane poles, 181, may subsequently be transformed (by transform block 174 in this example) into z-plane poles, 182. For example, the MATLAB BILINEAR function may be used by transform block 174 to apply this transformation:

$$P ( N ) = b i l i n e a r ( P ( N ) , 1 , 1 , 48000 ) ,$$

or this transformation:

$$P ( N ) = b i l i n e a r ( P ( N ) , 1 , 1 , 48 \; 000 , FP ) ,$$

where Fₚ represents the upper frequency (as used in Equation 15), and 48000 is the sample-rate according to this embodiment. It will be appreciated that alternative sample-rates may be used, including but not limited to 16000, 32000, 44100 or 96000.

It will be appreciated by those skilled in the art, that other non-linear processing methods may be employed to facilitate the mapping of a chosen delay, d, 140, to a set of all-pass poles, 182. In an alternative embodiment, the polynomial functions applied by the delay processing block 172 may be used to define the frequency and Q of the poles, and the non-linear mapping process applied by the mapping block 173 may convert the frequency and Q values to a respective pole location. In another embodiment, the non-linear mapping process applied by the mapping block 173 may determine the z-domain pole locations, removing the need for the bilinear transform of the transform block 174.

It will also be appreciated that, by forming additional conjugate poles (for each of the complex poles in the set 182), and by forming each filter zero as the reciprocal of each corresponding pole, an all-pass filter response may be derived—by all-pass filter response block 175 in this example—and this all-pass filter will be causal.

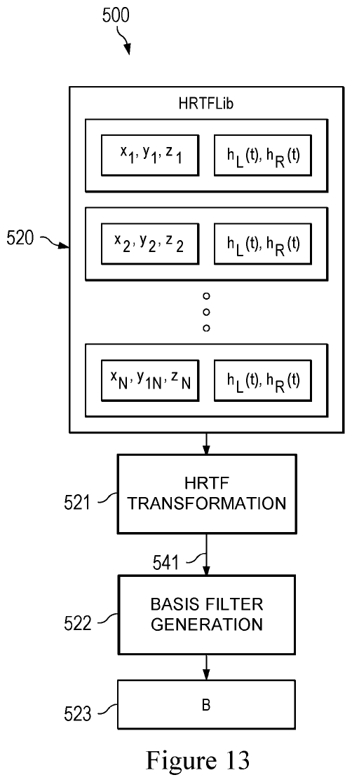

FIG. 13 illustrates a process of producing a set of basis filters from a set of HRTFs. In some examples, the blocks of FIG. 13 may be implemented, at least in part, by the control system 110 of FIG. 1A. FIG. 13 shows an arrangement 500 wherein an original HRTF library 520 is processed—by HRTF transformation block 521 in this example—to produce a modified HRTF library 541. In this example, the inter-aural delay components inherent in the HRTF filters of the original HRTF set are replaced by all-pass filters that satisfy Equation 15, and the modified HRTF library has reduced inter-aural phase at frequencies greater than Fₚ. The modified HRTFs 521 are processed—by basis filter generation block 522 in this example—to produce a set of basis-filters 523, according to a fitting process such as the fitting process of Equation 10.

The basis-filter set 523 has fewer members than the set of modified HRTFs. In this context, a “member” of the basis-filter set 523 is one of the basis filters of the basis-filter set 523 and a “member” of the set of modified HRTFs is one of the HRTFs in the set of modified HRTFs. According to some examples, the basis-filter set 523 may have at least an order of magnitude fewer members than the set of modified HRTFs. For example, the set of modified HRTFs may have hundreds or thousands of members in some instances, whereas the basis-filter set 523 may include fewer than 100 members, fewer than 50 members, or even fewer than 20 members. Accordingly, the basis-filter set 523 forms a compact representation of the original HRTF set 520.

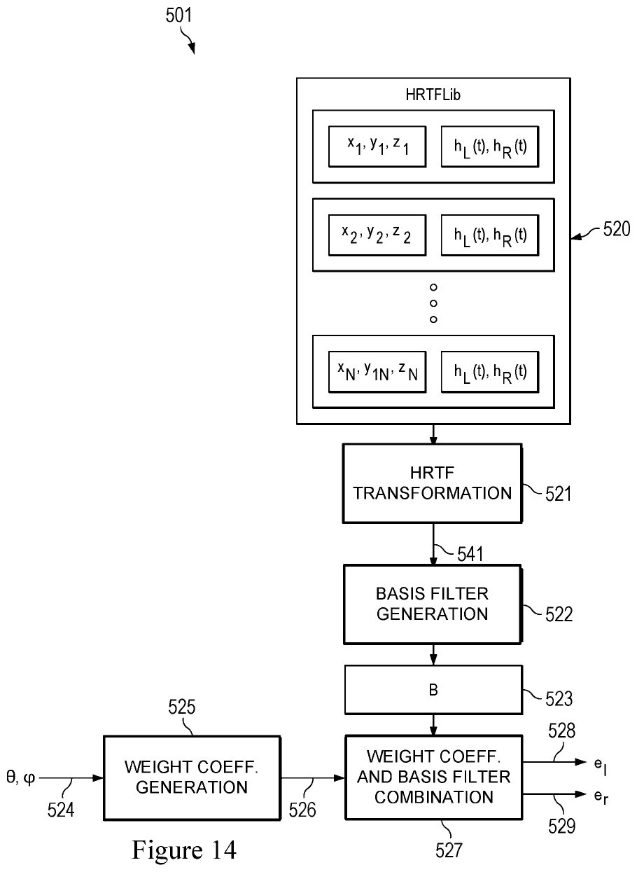

FIG. 14 illustrates processes of producing a set of basis filters from a set of HRTFs and of using the set of basis filters to form left and right HRTF filters. In some examples, the blocks of FIG. 14 may be implemented, at least in part, by the control system 110 of FIG. 1A. FIG. 14 shows an arrangement 501 wherein an original HRTF library 520 is processed by HRTF transformation block 521 to produce a modified HRTF library 541, which is then processed be basis filter generation block 522 to produce a set of basis-filters 523. A direction of arrival 524 (which may be defined according to spherical coordinates (θ, φ), a unit-vector (x, y, z), or by other forms known in the art) is processed by weight coefficient generation block 525 to form weight coefficients 526. In some embodiments, weight coefficients may be defined according to spherical-harmonic panning equations, and the basis-filters may likewise be adapted to be compatible with spherical-harmonic panning equations, e.g., gₖ(x, y, z) in Equation 7.

In this example, the weight coefficient and basis filter combination block 527 combines weight coefficients 526 with basis-filters 523 to form the left and right ear HRTF filters (528, 529 respectively) that represent the modified HRTF for the specified direction of arrival. The weight coefficient and basis filter combination block 527 may, for example, be implemented according to Equation 7 when the basis-filters represent a symmetric HRTF set. The weight coefficient and basis filter combination block 527 may, for example, be implemented according to Equation 6 when the basis-filters represent an HRTF set that includes asymmetry.

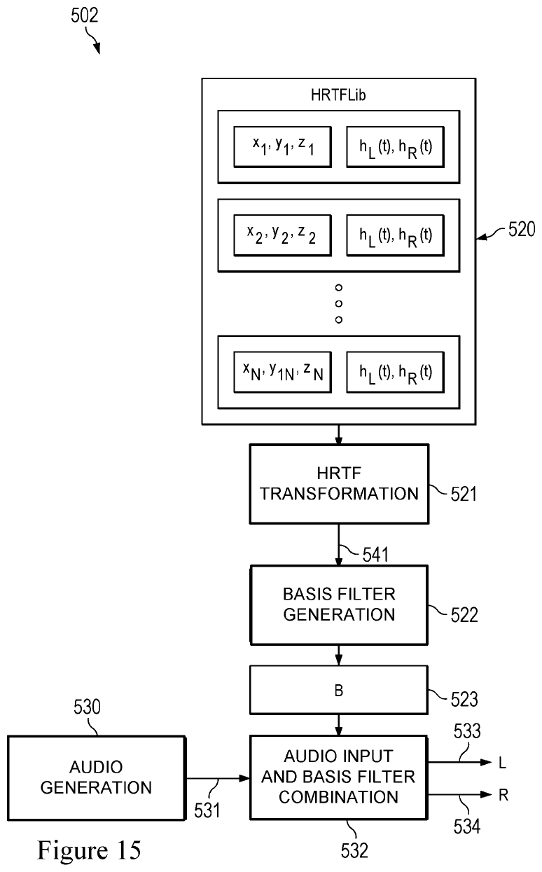

FIG. 15 illustrates processes of producing a set of basis filters from a set of HRTFs and of using the set of basis filters to form left and right audio signals. In some examples, the blocks of FIG. 15 may be implemented, at least in part, by the control system 110 of FIG. 1A. FIG. 15 shows an arrangement 502 wherein an original HRTF library 520 is processed by HRTF transformation block 521 to produce a modified HRTF library 541, which is then processed by basis filter generation block 522 to produce a set of basis-filters 523. According to this example, an audio generation block 530 produces audio signals 531 in a form associated with a scene-based audio format, such as Ambisonics or Higher-Order Ambisonics. Audio generation block 530 may be, or may include, an audio decoder adapted to produce a multi-channel audio bitstream from a transmitted or stored encoded bitstream. Alternatively, audio generation block 530 may be, or may include, an audio capture and/or processing device adapted to produce scene-based audio signals 531 representing a spatial audio scene.

According to this example, audio input and basis filter combination block 532 is adapted to combine audio signals 531 with the basis-filters 523 to produce leaf and right ear audio signals (533, 534 respectively). The audio input and basis filter combination block 532 may, in some examples, be configured to implement a convolution process, which may be implemented according to known time-domain or frequency-domain methods, as known in the art.

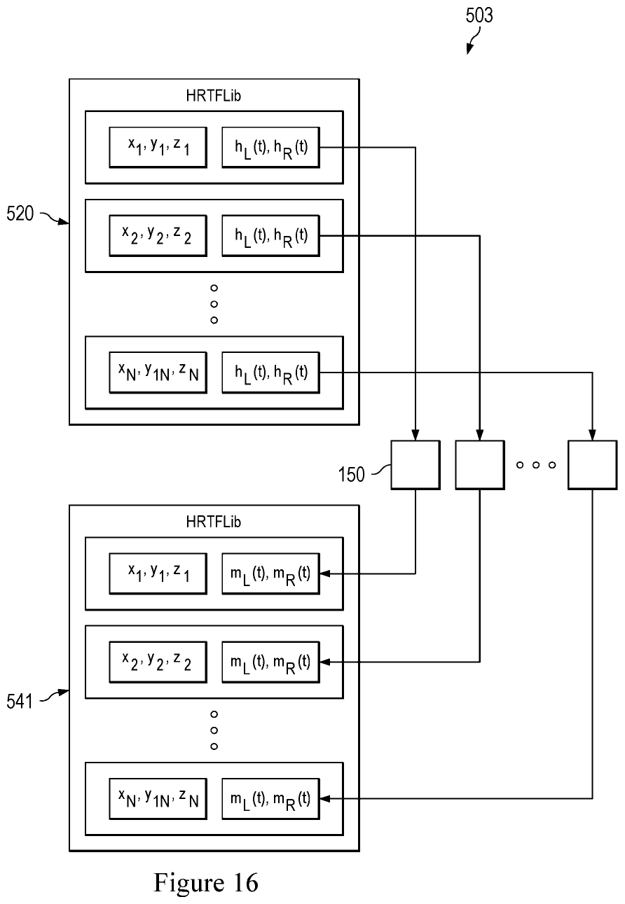

FIG. 16 shows additional details of the HRTF transformation block of FIGS. 13-15 according to some implementations. In some examples, the blocks of FIG. 16 may be implemented, at least in part, by the control system 110 of FIG. 1A. FIG. 16 shoes a more detailed view of the process in the upper part of FIGS. 13-15 (the conversion from an “original” HRTF library 520 to a “modified” HRTF library 521). According to this example, each Left/Right HRTF pair is processed by a corresponding HRTF transformation sub-block 150.

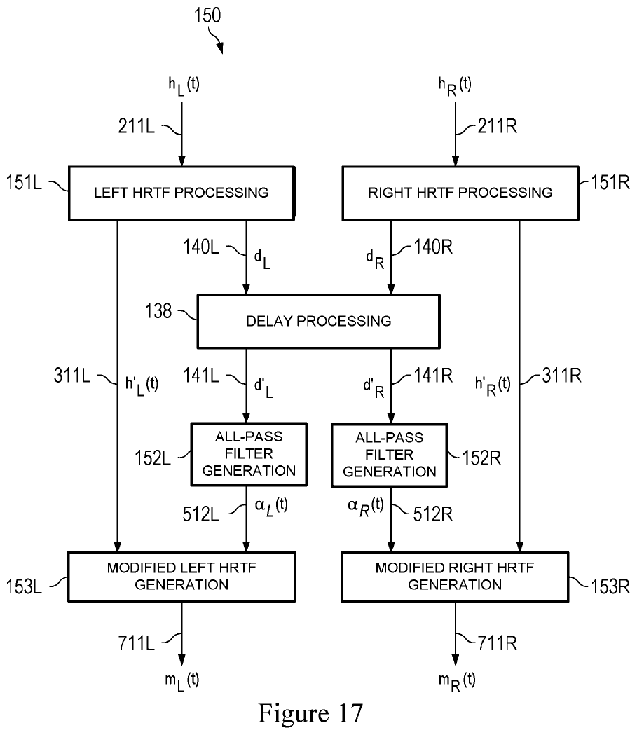

FIG. 17 shows additional details of the HRTF transformation sub-blocks of FIG. 16 according to some implementations. In some examples, the blocks of FIG. 17 may be implemented, at least in part, by the control system 110 of FIG. 1A. FIG. 17 shows an example of the HRTF transformation sub-block 150 150 in which the L and R HRTFs (211L and 211R) are processed by left HRTF processing block 151L and right HRTF processing block 151R, respectively, to extract the un-delayed impulse responses 311L/R and the delay 140L/R. Then, the two delays 140L/R are processed by the delay processing block 138 to produce new simplified delays 141L/R. The simplified delays are each processed by all-pass filter generation blocks 152L and 152R to form the all-pass filters 512L/R. According to this example, the modified left HRTF generation blocks 153L and 153R are configured to combine the non-delayed impulse responses 311L/R with the all-pass filters 512L/R to form the modified HRTF pair 711L/R.

### Example Delay Definitions for Each Ear

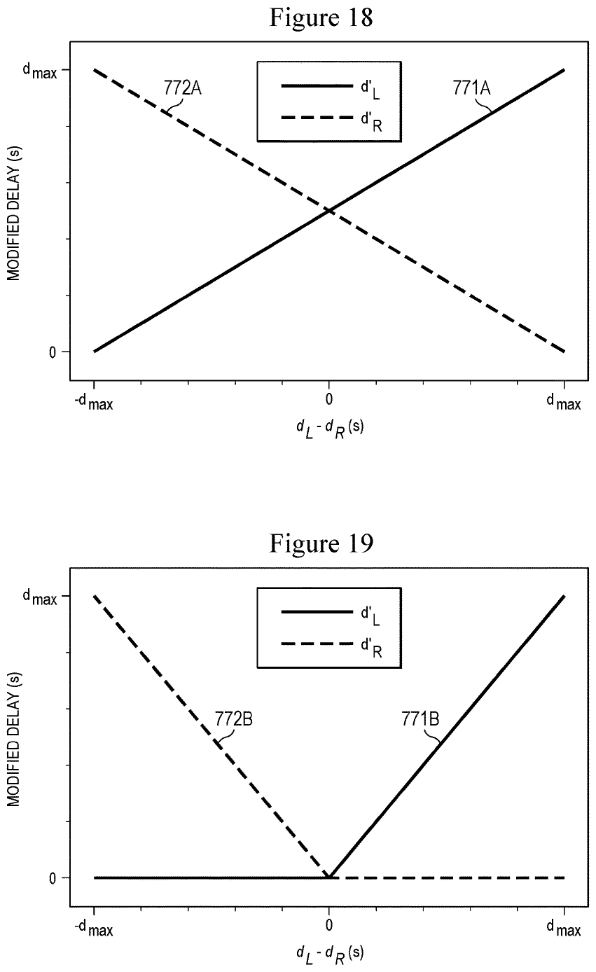

The delay processing block 138 of FIG. 17 is configured to respond to the difference between the delays 140L/R to generate new delay values 141L/R. FIGS. 18, 19, and 20 show examples of functions that may be implemented by the delay processing block 138 of FIG. 17. For FIGS. 18, 19, and 20, the corresponding functions are:

According to FIG. 18:

$$\begin{matrix}{d}_{L}^{′} = \frac{{d}_{max}}{2} + \frac{{d}_{L} - {d}_{R}}{2} \\ {d}_{R}^{′} = \frac{{d}_{max}}{2} - \frac{{d}_{L} - {d}_{R}}{2}\end{matrix} \qquad ( 19 )$$

According to FIG. 19:

$${d}_{L}^{′} = max ( 0 , {d}_{L} - {d}_{R} ) {d}_{R}^{′} = max ( 0 , {d}_{R} - {d}_{L} ) \qquad ( 20 )$$

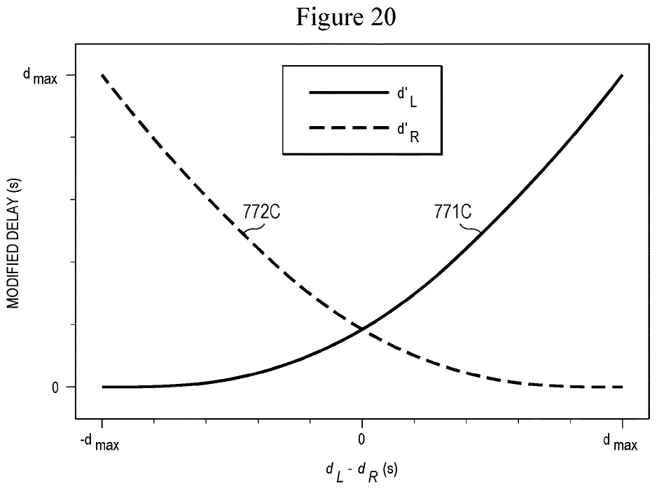

According to FIG. 20:

$$\begin{matrix}{d}_{L}^{′} = \frac{{d}_{max}}{2} ( 1 - \frac{2}{π} cos ( \frac{π}{2} \frac{{d}_{L} - {d}_{R}}{{d}_{max}^{2}} ) ) + \frac{{d}_{L} - {d}_{R}}{2} \\ {d}_{R}^{′} = \frac{{d}_{max}}{2} ( 1 - \frac{2}{π} cos ( \frac{π}{2} \frac{{d}_{L} - {d}_{R}}{{d}_{max}^{2}} ) ) - \frac{{d}_{L} - {d}_{R}}{2}\end{matrix} \qquad ( 21 )$$

In Equation 21, dₘₐₓ represents the largest expected value of |d_{L}−d_{R}|.

An important property of the function implemented by the delay processing blo138 is that it produces modified delays d′_{L} and d′_{R} that satisfy: d′_{L}−d′_{R}=d₄−d_{R}, so that the inter-aural delay difference between the left (L) and right (R) HRTFs is preserved.

The function of FIG. 20—which is the same as the function used in the example MATLAB code, shown below—is defined to have the following properties: (a) the delay for both ears is a smooth function, and (b) the ear with lower delay (which is also typically the ear with larger amplitude) will have less delay variation (since the slope of the curve is lower when the delay is lower).

In some further embodiments, the left HRTF processing block 151L and the right HRTF processing block 151R may be adapted to produce un-delayed impulse responses 311L and 311R, respectively, that are minimum-phase filter responses.

According to some embodiments, the left HRTF processing block 151L and the right HRTF processing block 151R may be implemented according to the following steps:
1. Determine the frequency response of an original HRTF filter, e.g. R_{orig,n}(f) as defined in Equation 11.
2. Determine the magnitude response of the original HRTF filter:

$$M ( f ) = \vert {R}_{ori ℊ , n} ( f ) \vert$$

3. Determine the frequency response of a new (un-delayed) minimum-phase filter, according to a method as known in the art, employing the Hilbert transform:

$${R}^{′} ( f ) = mag2min\_phase \{ M ( f ) \} = exp ( hilbert ( \overline{ln ( M ( f ) )} ) )$$

4. Determine the phase response of the original filter and the un-delayed filter:

$${Ψ}_{ori ℊ} ( f ) = unwrap ( angle ( {R}_{ori ℊ , n} ( f ) ) )$$

$${Ψ}_{minp} ( f ) = unwrap ( angle ( {R}^{′} ( f ) ) )$$

where the angle( ) function extracts the phase component of a complex frequency response, and the unwrap( ) operation is known in the art as a method for removing discontinuities in the extracted phase response by adding a multiple of 2π at each frequency (e.g., the MATLAB UNWRAP( ) function).
5. Determine the delay associated with the original HRTF filter as:

$$d = \frac{{Ψ}_{minp} ( {f}_{d} ) - {Ψ}_{ori ℊ} ( {f}_{d} )}{2 π {f}_{d}}$$

In some examples, the Delay Measurement Frequency, f_{d}, is chosen to be a value in the range 300 Hz-1600 Hz. In a detailed example, f_{d}=1200 Hz. In some other examples, f_{d} may be a value in the range 300 Hz-1200 Hz, a value in the range 600 Hz-1800 Hz, a value in the range 1000 Hz-1400 Hz, or a value in some other frequency range.

In some embodiments, delay, d, and the minimum-phase response, R′(f), as determined according the to the methods above, are used to determine the modified HRTF response, R_{mod,n}(f), according to the following steps:
1. For each of the original left and right ear HRTF filters (for a given direction-of-arrival), use the procedure above to determine the delay, d, and the minimum-phase response, R′(f), and label them as:

$$\begin{matrix}Left ear delay = {d}_{L} & Left ear undelayed - filter = {R}_{L}^{′} ( f ) \\ Right ear delay = {d}_{R} & Right ear undelayed - filter = {R}_{R}^{′} ( f )\end{matrix}$$

2. Determine the maximum inter-aural delay difference:

$${d}_{max} = {max}_{n = 1 …N} \vert {d}_{L} - {d}_{R} \vert$$

so that dₘₐₓ defines the largest inter-aural delay for all directions of arrival (n=1 . . . . N).
3. Determine new left and right ear delay values, d′_{L} and d′_{R}, so that:

$${d}_{L}^{′} - {d}_{R}^{′} = {d}_{L} - {d}_{R}$$

where the left and right ear delay values d′y and d′_{R} may be determined according to Equation 21.
4. Determine all-pass filter frequency responses:

$$\begin{matrix}{ϕ}_{L} ( f ) = ℱ \{ \text{?} ( {d}_{L}^{′} , t ) \} \\ {ϕ}_{R} ( f ) = ℱ \{ \text{?} ( {d}_{R}^{′} , t ) \}\end{matrix}$$

where [symbol] (d, t) may be the function described in Equation 13, which determines the all-pass filter phase response associated with the delay d.
5. Determine new modified HRTF filters:

$$\begin{matrix}Left ear : {R}_{mod , n} ( f ) = {R}_{L}^{′} ( f ) {ϕ}_{L} ( f ) \\ Right ear : {R}_{mod , n} ( f ) = {R}_{R}^{′} ( f ) {ϕ}_{R} ( f )\end{matrix}$$

### Example MATLAB Implementation

The following MATLAB implementation provides additional details according to disclosed methods. An example of a MATLAB function that determines an HRTF basis filter set from an existing HRTF library is shown below:

```
FUNCTION IR_DATA = GENERATE_HOA_HRIRS_MOD_LENS(ORDER, SOFA_PATH, ...
    SOFA_FILE_NAME, IR_LEN)
% HRIR CONVERTOR - TAKES SPHERE SAMPLED HRIRS AND CONVERTS THEM TO
% HOA HRIRS.
%
% ORDER - HOA ORDER TO BE CONVERTED TO.
% SOFA_PATH - PATH TO THE DIRECTORY THAT CONTAINS THE SOFA FILES TO BE
% CONVERTED.
% SOFA_FILE - FILE NAME OF THE HRTFS TO BE CONVERTED
% IR_LEN - LENGTH OF THE IRS TO BE USED.
%
% LOAD IN THE SUPPORT COEFS
LOAD(‘HRTF_SUPPORT_COEFS.MAT’, ‘HRTF_SUPPORT_COEFS’);
RMSSPHERE = HRTF_SUPPORT_COEFS(ORDER).RMSSPHERE;
LR_ODD = HRTF_SUPPORT_COEFS(ORDER).LR_ODD;
XYZ_TO_PAN = HRTF_SUPPORT_COEFS(ORDER).XYZ_TO_PAN;
ALLPASS = HRTF_SUPPORT_COEFS(ORDER).AP;
% CHOOSE A HI-RES SET OF POSITIONS TO SAMPLE THE INPUT HRTFS
VS_HI_RES = LOAD(“SPHERE_PACKING_2562.MAT”);
VS_HI_RES = VS_HI_RES.VS_HI_RES;
N = 512;
% FETCH THE HRTFS, AND FIGURE OUT THE ITD FOR EVERY DIRECTION
H = HRTF_LIBRARY_LOADER( );
H.READSOFA(CHAR(FULLFILE(SOFA_PATH, SOFA_FILE_NAME)));
IRS_HI_RES = H.XYZ_TO_IR(VS_HI_RES);
FRS_HI_RES = M_DFT(IRS_HI_RES, N); % FREQ X EARS X VS
FRS_HI_RES_MINP = MAG2MIN_PHASE(FRS_HI_RES);
EXCESS_PHASE = SQUEEZE(UNWRAP(DIFF(ANGLE(FRS_HI_RES), 1, 2) - ...
DIFF(ANGLE(FRS_HI_RES_MINP), 1, 2)));
BIN1200 = CEIL( 1200/24000*N );
ITD_HI_RES = EXCESS_PHASE(BIN1200,:)‘ / ((BIN1200−0.5)/N*24000*2*PI);
MAXDEL = MAX(ITD_HI_RES, [ ], ‘ALL’);
% CREATE 2 EARS
EAR_DELS_HI_RES = (REPMAT(ITD_HI_RES, 1, 2) .* [0.5 −0.5]) + ...
0.5*MAXDEL .* (1 - 2/PI*COS(ITD_HI_RES * PI/2 / MAXDEL));
MRS_HI_RES = ABS(FRS_HI_RES_MINP);
% GENERATE PERMUTATION
[~, PERM] = ISMEMBERTOL(...
VS_HI_RES‘, VS_HI_RES’.*[1,−1,1], ...
1E−4, “BYROWS”,TRUE);
MRS_HI_RES(:,2,:) = MRS_HI_RES(:,2,PERM);
NEW_FREQRESP_L = MAG2MIN_PHASE(SQUEEZE(MEAN(MRS_HI_RES, 2))) .* ...
M_DFT(GET_ALLPASS_IRS(ALLPASS, EAR_DELS_HI_RES(:, 1) * 48000), N, 1);
% CREATE SOLVING WEIGHTS
WEIGHTS = ABS(NEW_FREQRESP_L);
WEIGHTS(WEIGHTS < 0.1) = 0.1;
WEIGHTS = 1 ./ (SQRT(SQRT(WEIGHTS)));
% SOLVE TO COMPUTE THE HOA FREQUENCY RESPONSES.
[M, ~] = SIZE(XYZ_TO_PAN);
FREQRESP_HOA = ZEROS(M, N);
FOR K=1:N
AW = NEW_FREQRESP_L(K,:) .* WEIGHTS(K,:);
BW= XYZ_TO_PAN .* WEIGHTS(K,:);
FREQRESP_HOA(:,K) = AW * PINV(BW, 0);
END
FREQRESP_HOA_ABS2 = REAL(FREQRESP_HOA.*CONJ(FREQRESP_HOA));
FREQRESP_HOA = FREQRESP_HOA .* ...
  MAG2MIN_PHASE(((FREQRESP_HOA_ABS2‘ * RMSSPHERE.\hat{ }2) .\hat{ } (−0.5)), 1).’;
% CONVERT BACK TO IRS
IR_HOA = M_IDFT(FREQRESP_HOA.‘, [ ], 1);
IR_HOA = CAT(3, IR_HOA, (IR_HOA .* (1−2*LR_ODD)’));
% PUT MATRIX DIMENSIONS IN THE RIGHT ORDER
IR_HOA = PERMUTE(IR_HOA, [3, 1, 2]);
% GET THE IRS TO THE RIGHT LENGTH
IR_HOA = IR_HOA(:,1:IR_LEN,:) .* ...
  SIN(INTERP1([0,150/192*IR_LEN,IR_LEN+1],[1,1,0]*PI/2, 1:IR_LEN));
IR = PERMUTE(IR_HOA, [2, 1, 3]);
IR_DATA = IR;
  The GET_ALLPASS_IRS( ) function may be defined according to the MATLAB code below.
  FUNCTION IR = GET_ALLPASS_IRS(ALLPASS, DELS)
  XSET = POLY2XSET(ALLPASS.PROTO_POLY, (DELS(:)‘−
  16)*ALLPASS.UPPER_FREQ/ALLPASS.PROTO_BW);
  IR = MAKEIRS(XSET, ALLPASS.UPPER_FREQ);
  END
  FUNCTION XSET = POLY2XSET(P, DELS_SAMPLES)
  XSET = ZEROS(SIZE(P,1), NUMEL(DELS_SAMPLES));
  FOR K = 1:SIZE(P,1)
    XSET(K,:)=POLYVAL(P(K,:),DELS_SAMPLES(:)’/32);
  END
  END
  FUNCTION IRS = MAKEIRS(X,BW)
  IRS = MAP_POLES2IRS( MAP2POLES(X,BW) );
  END
  FUNCTION P = MAP2POLES(X,BW)
  P = MAP_2_S_POLES(X) *BW;
  FOR K = 1:SIZE(P(:,:),2)
    P(:,K) = BILINEAR(P(:,K),P(:,K),1,48000,BW);
  END
  END
  FUNCTION IRS = MAP_POLES2IRS(P)
  IRS = ZEROS(512,SIZE(P(:,:),2));
  FOR K = 1:SIZE(IRS,2)
    [~,A] = ZP2TF(P(:,K),P(:,K),1);
    IRS(:,K) = FILTER(FLIPLR(A),A, [1;ZEROS(511,1)]);
  END
  END
  FUNCTION P = MAP_2_S_POLES(X)
  ORDER = SIZE(X,1);
  IF ORDER==0
    P=[ ];
  ELSEIF ORDER==1
    P=−2*PI*X;
  ELSE
    ANG = ATAN(X(2,:))/2+PI/4;
    P = [−2*PI*X(1,:).*EXP(1I*[1;−1]*ANG) ; MAP_2_S_POLES(X(3:END,:))];
  END
  END
```

FIG. 21 is a flow diagram that outlines one example of a method that may be performed by an apparatus or system such as those disclosed herein. The blocks of method 2100, like other methods described herein, are not necessarily performed in the order indicated. In some implementation, one or more of the blocks of method 2100 may be performed concurrently. Moreover, some implementations of method 2100 may include more or fewer blocks than shown and/or described. The blocks of method 2100 may be performed by one or more devices, which may be (or may include) a control system such as the control system 110 that is shown in FIG. 1A and described above.

In this example, method 2100 is an audio processing method. According to this example, block 2105 involves obtaining, by a control system, a first set of HRTFs. The first set of HRTFs may, for example, be the original HRTF library 520 of FIGS. 13-16.

In this example, block 2110 involves transforming, by the control system, the first set of HRTFs to a second set of HRTFs. The second set of HRTFs may, for example, be the modified HRTF library 541 of FIGS. 13-16. According to this example, the transforming process of block 2110 involves replacing delay components of the first set of HRTFs with all-pass filters in the second set of HRTFs. In this example, the transforming process of block 2110 also involves adjusting a phase response of each of the all-pass filters in the second set of HRTFs such that each inter-aural phase response is substantially linear for frequencies below an associated threshold frequency of the corresponding all-pass filter and each phase response has reduced inter-aural phase difference for frequencies above the associated threshold frequency of the corresponding all-pass filter. The threshold frequency may, for example, be the frequency at which the alternative phase curve 412 diverges from the linear phase response 411 of FIG. 5. The threshold frequency may, for example, be a frequency in the range of 1300 Hz-1500 Hz, a frequency in the range of 1000 Hz-1600 Hz, a frequency in the range of 1200 Hz-1600 Hz, etc. In some examples, the threshold frequency may be 1400 Hz.

In this example, block 2115 involves outputting a result of adjusting the phase response of each of the all-pass filters in the second set of HRTFs. Outputting the result may, for example, involve storing the result, transmitting the result, providing the result for further processing, or combinations thereof.

According to some examples, method 2100 may involve additional processes such as those described herein with reference to FIG. 13. In some such examples, method 2100 also may involve defining, by the control system, a set of basis filters based on the second set of HRTFs. The set of basis filters may have fewer members than the second set of HRTFs. In some examples, the set of basis filters may have at least an order of magnitude fewer members than the second set of HRTFs.

In some examples, method 2100 also may involve processes such as those described herein with reference to FIG. 14 or FIG. 15. In some such examples, method 2100 also may involve obtaining, by the control system, a bitstream of input audio data in an input audio format and combining, by the control system, the input audio data with one or more basis filters of the set of basis filters to produce left audio data and right audio data. According to some such examples, method 2100 also may involve outputting, by the control system, the left audio data and the right audio data. Outputting the left audio data and the right audio data may involve storing the left audio data and the right audio data, transmitting the left audio data and the right audio data, providing, by the control system, the left audio data and the right audio data to a set of loudspeakers for playback, providing the left audio data and the right audio data for further processing—for example, to other modules implemented by the control system to another control system—or combinations thereof.

According to some examples, the transforming process of block 2110 may involve processes such as those described herein with reference to FIGS. 16 and 17. According to some such examples, block 2110 may involve obtaining left ear HRTFs and right ear HRTFs from the first set of HRTFs, identifying a left ear non-delayed impulse response and a left ear delay from each of the left ear HRTFs and identifying a right ear non-delayed impulse response and a right ear delay from each of the right ear HRTFs. In some such examples, block 2110 may involve producing left ear all-pass filters, each of the left ear all-pass filters being based, at least in part, on an instance of the left ear delays, and producing right ear all-pass filters, each of the right ear all-pass filters being based, at least in part, on an instance of the right ear delays. In some such examples, block 2110 may involve combining instances of the left ear and a right ear non-delayed impulse responses with corresponding instances of the left ear and right ear all-pass filters to produce HRTF pairs of the second set of HRTFs.

In some such examples, block 2110 may involve producing modified left ear delay values and right ear delay values based on one or more of the extracted left ear delays and right ear delays. The left ear all-pass filters and right ear all-pass filters may be based upon the modified left ear delay values and right ear delay values, respectively. In some examples, producing instances of the modified left ear delay values and right ear delay values may involve determining a difference between an extracted left ear delay and an extracted right ear delay. According to some examples, producing instances of the modified left ear delay values and right ear delay values may involve determining the largest expected difference between an extracted left ear delay and an extracted right ear delay.

According to some examples, a difference between an extracted left ear delay and an extracted right ear delay may equal a difference between a corresponding modified left ear delay value and a modified right ear delay value. In some examples, the modified left ear delay values and the modified right ear delay values may correspond to smooth functions, such as those shown in FIG. 20. According to some examples, each pair of the modified left ear delay values and modified right ear delay values may include a lower delay value and a higher delay value. In some such examples, the lower delay value may have less delay variation than the higher delay value.

In some examples, the non-delayed impulse responses may be minimum-phase filter responses.

According to some examples, extracting each left ear non-delayed impulse response, each right ear non-delayed impulse response, each left ear delay and each right ear delay from each of the left ear and right ear HRTFs may involve: determining a frequency response of an original HRTF filter of the first set of HRTFs; determining a magnitude response of the original HRTF filter; determining a minimum-phase frequency response of a new non-delayed minimum-phase filter; determining a phase response of the original HRTF filter and a phase response of the new non-delayed minimum-phase filter; and determining a delay associated with the original HRTF filter based, at least in part, on the phase response of the original HRTF filter and the phase response of the new non-delayed minimum-phase filter. In some such examples, determining the minimum-phase frequency response may involve implementing a Hilbert transform involving the magnitude response of the original HRTF filter. According to some examples, determining the delay associated with the original HRTF filter may also be based, at least in part, on a delay measurement frequency in a range of 300 Hz to 1600 Hz.

In some examples, an all-pass phase response may deviate from a linear-ramp phase response and may smoothly approach zero phase for frequencies above the threshold frequency. The alternative phase curve 412 FIG. 5 provides one such example.

According to some examples, a control system that is configured to implement the method 2100 is also configured to implement at least part of a codec for Immersive Voice and Audio Services (IVAS). FIG. 1D shows one such example.

The above description illustrates various embodiments of the present disclosure along with examples of how aspects of the present disclosure may be implemented. The above examples and embodiments should not be deemed to be the only embodiments, and are presented to illustrate the flexibility and advantages of the present disclosure as defined by the following claims. Based on the above disclosure and the following claims, other arrangements, embodiments, implementations and equivalents will be evident to those skilled in the art and may be employed without departing from the spirit and scope of the disclosure as defined by the claims.

1. An audio processing method for a control system including one or more processors, the method comprising:
obtaining, by the control system, a first set of head-related transfer functions (HRTFs);
transforming, by the control system, the first set of HRTFs to a second set of HRTFs, wherein the transforming comprises:
replacing delay components of the first set of HRTFs with all-pass filters in the second set of HRTFs;
adjusting a phase response of each of the all-pass filters in the second set of HRTFs such that:
each inter-aural phase response is substantially linear for frequencies below an associated threshold frequency of the corresponding all-pass filter, and
each phase response has reduced inter-aural phase difference for frequencies above the associated threshold frequency of the corresponding all-pass filter; and
outputting the second set of HRTFs.

2. The audio processing method of claim 1, wherein outputting the second set of HRTFs involves storing the second set of HRTFs, transmitting the second set of HRTFs to a device that is configured to process audio data, providing the second set of HRTFs for further processing, or combinations thereof.

3. The audio processing method of claim 1, further comprising:
defining, by the control system, a set of basis filters based on the second set of HRTFs, wherein the set of basis filters has fewer members than the second set of HRTFs;
obtaining, by the control system, a bitstream of input audio data in an input audio format;
combining, by the control system, the input audio data with one or more basis filters of the set of basis filters to produce left audio data and right audio data; and
outputting, by the control system, the left audio data and the right audio data.

4. The audio processing method of claim 3, wherein outputting the left audio data and the right audio data involves storing the left audio data and the right audio data, transmitting the left audio data and the right audio data, providing, by the control system, the left audio data and the right audio data to a set of loudspeakers for playback, providing the left audio data and the right audio data for further processing, or combinations thereof.

5. The audio processing method of claim 1, wherein the transforming further comprises:
obtaining left ear HRTFs and right ear HRTFs from the first set of HRTFs;
identifying a left ear non-delayed impulse response and a left ear delay from each of the left ear HRTFs;
identifying a right ear non-delayed impulse response and a right ear delay from each of the right ear HRTFs;
producing left ear all-pass filters, each of the left ear all-pass filters being based, at least in part, on an instance of the left ear delays;
producing right ear all-pass filters, each of the right ear all-pass filters being based, at least in part, on an instance of the right ear delays; and
combining instances of the left ear and a right ear non-delayed impulse responses with corresponding instances of the left ear and right ear all-pass filters to produce HRTF pairs of the second set of HRTFs.

6. The audio processing method of claim 5, further comprising producing modified left ear delay values and right ear delay values based on one or more of the extracted left ear delays and right ear delays, wherein the left ear all-pass filters and right ear all-pass filters are based upon the modified left ear delay values and right ear delay values.

7. The audio processing method of claim 6, wherein producing instances of the modified left ear delay values and right ear delay values involves determining a difference between an extracted left ear delay and an extracted right ear delay.

8. The audio processing method of claim 6, wherein producing instances of the modified left ear delay values and right ear delay values involves determining a largest expected difference between an extracted left ear delay and an extracted right ear delay.

9. The audio processing method of claim 6, wherein a difference between an extracted left ear delay and an extracted right ear delay equals a difference between a corresponding modified left ear delay value and a modified right ear delay value.

10. The audio processing method of claim 6, wherein the modified left ear delay values and the modified right ear delay values correspond to smooth functions.

11. The audio processing method of claim 6, wherein each pair of the modified left ear delay values and modified right ear delay values includes a lower delay value and a higher delay value and wherein the lower delay value has less delay variation than the higher delay value.

12. The audio processing method of claim 5, wherein the non-delayed impulse responses are minimum-phase filter responses.

13. The audio processing method of claim 5, wherein extracting each left ear non-delayed impulse response, each right ear non-delayed impulse response, each left ear delay and each right ear delay from each of the left ear and right ear HRTFs involves:
determining a frequency response of an original HRTF filter of the first set of HRTFs;
determining a magnitude response of the original HRTF filter;
determining a minimum-phase frequency response of a new non-delayed minimum-phase filter;
determining a phase response of the original HRTF filter and a phase response of the new non-delayed minimum-phase filter; and
determining a delay associated with the original HRTF filter based, at least in part, on the phase response of the original HRTF filter and the phase response of the new non-delayed minimum-phase filter.

14. The audio processing method of claim 13, wherein determining the minimum-phase frequency response involves implementing a Hilbert transform involving the magnitude response of the original HRTF filter.

15. The audio processing method of claim 13, wherein determining the delay associated with the original HRTF filter is also based, at least in part, on a delay measurement frequency in a range of 300 Hz to 1600 Hz.

16. The audio processing method of claim 3, wherein the set of basis filters has at least an order of magnitude fewer members than the second set of HRTFs.

17. The audio processing method of claim 1 wherein an all-pass phase response deviates from a linear-ramp phase response and smoothly approaches zero phase for frequencies above the threshold frequency.

18. The audio processing method of claim 1, wherein the control system corresponds to at least part of a codec for Immersive Voice and Audio Services (IVAS).

19. One or more non-transitory computer-readable media storing instructions that, when executed by one or more processors, cause the one or more processors to perform operations of the method of claim 1.

20. An audio processor device to process input audio data, the audio processor device comprising:
a receiver unit configured to receive the input audio data;
a computer unit configured to:
retrieve a first set of head-related transfer functions (HRTFs);
transform the first set of HRTFs to a second set of HRTFs, wherein the transforming comprises:
replacing delay components of the first set of HRTFs with all-pass filters in the second set of HRTFs;
adjusting a phase response of each of the all-pass filters in the second set of HRTFs such that:
each inter-aural phase response is substantially linear for frequencies below an associated threshold frequency of the corresponding all-pass filter, and
each phase response has reduced inter-aural phase difference for frequencies above the associated threshold frequency of the corresponding all-pass filter; and
output the second set of HRTFs.

21. The audio processor device of claim 20, wherein outputting the second set of HRTFs involves storing the second set of HRTFs, transmitting the second set of HRTFs to a device that is configured to process audio data, providing the second set of HRTFs for further processing, or combinations thereof.

22. The audio processor device of claim 20, wherein the computer unit is further configured to:
define a set of basis filters based on the second set of HRTFs, wherein the set of basis filters has fewer members than the second set of HRTFs;
obtain a bitstream of input audio data in an input audio format;
combine the input audio data with one or more basis filters of the set of basis filters to produce left audio data and right audio data; and
output the left audio data and the right audio data.

23. The audio processor device of claim 22, wherein outputting the left audio data and the right audio data involves storing the left audio data and the right audio data, transmitting the left audio data and the right audio data, providing, by the control system, the left audio data and the right audio data to a set of loudspeakers for playback, providing the left audio data and the right audio data for further processing, or combinations thereof.

24. The audio processor device of claim 22, further comprising a storage device that is configured to store the first HRTFs, the second HRTFs, the left audio data, the right audio data, the input audio data, or combinations thereof.

25. The audio processor device of claim 24, wherein the storage device comprises one or more of a random-access memory, a read-only memory, and a non-transitory computer readable medium.

26. The audio processor device of claim 20, wherein the device corresponds to at least part of a codec for Immersive Voice and Audio Services (IVAS).
